(19) United States
(12) Patent Application Publication
(10) Pub. No.: US 2019/0045594 A1
(43) Pub. Date: Feb. 7, 2019

(54) TIMER LIGHT LEVEL SETTING SYSTEM AND PROCESS

(71) Applicant: POWERLINE CONTROL SYSTEMS, INC., NORTHRIDGE, CA (US)

(72) Inventor: MARSHALL LESTER, NORTHRIDGE, CA (US)

(73) Assignee: POWERLINE CONTROL SYSTEMS ,INC., Nortrhridg, CA (US)

(21) Appl. No.: 16/075,580

(22) PCT Filed: Feb. 10, 2017
(86) PCT No.: PCT/US2017/017562

§ 371 Date: Aug. 3, 2018

Related U.S. Application Data
(60) Provisional application No. 62/293,723, filed on Feb. 10, 2016.

(51) Int. Cl. H05B 33/08; H05B 37/02

(52) U.S. Cl. CPC H05B 33/0815; H05B 37/0227; H05B 33/0821; H05B 33/0845; H05B 37/0281

(57) ABSTRACT

A system for changing the light level in one or more lighting fixtures connected to a control device such as a timer or lighting panel using only conventional power relays in the timer or lighting panel, wherein the conventional power relays are used to turn power on and off to control circuits and also to send predefined messages to receiving modules installed in the lighting fixtures.

This application incorporates by reference and claims the benefit of U.S. provisional patent application 62/293,723, filed Feb. 10, 2016, and international application PCT/US2017/017562, filed Feb. 10, 2017.

### FIELD OF INVENTION

The present disclosure relates generally to systems and apparatus that enable remote control of one or more lighting fixtures or other loads by transmitting signals to conventional receiving modules that in turn enable multiple levels of light output from the lighting fixtures or different operations of other loads, whereby the conventional power relay function to both control the power to the lighting fixture(s) or other load(s) and to send signals to the fixture(s) to change the lighting level or to some other load(s) to change its/their operational state. The disclosed system and process for control can also be applied to loads, such as for example fans, heaters or motors that require or can benefit from relatively inexpensive, simple and reliable remote control. During operation these exemplary electrical loads often need to be set to one of multiple, different levels of power consumption to cause one of multiple, different operating characteristics such as more/less air flow; more/less heat output, and/or faster/slower revolutions per minute, in a manner analogous to higher/lower levels of light output from a lighting fixture.

### BACKGROUND

For over 100 years, in the commercial and industrial environment, simple timers and lighting control panels have been used to control lighting fixtures. The most common form of the timers and lighting control panels is a box mounted on the wall where power enters the box from a circuit breaker panel and power exits the box to power circuits connected to one or more lighting fixtures. Inside of the box is a conventional digital or mechanical timer that is setup or programmed by the user. A typical use would be a timer used to turn the fixtures off during times of no use or during daylight hours.

In a residential environment, dimming lighting loads on a circuit is typically accomplished by operation of a conventional switch that includes an electronic component, called a triac, which chops the AC waveform. This method was put in place over 50 years ago and remains the primary method of dimming incandescent light bulbs. It is believed that this remains the only, if not most used method for residential dimming of incandescent lights. But in a commercial or industrial environment where the lighting voltage is often 277 VAC there is no known triac-based dimmer or triac-based dimming method. Therefore, in a commercial or industrial environment, it is believed that the only previously known way to change the actual lighting level to any level other than 100% light was to add a relatively complex, hardwired or wireless controller, typically at great expense in terms of device costs, installation costs, and commissioning costs. These costs could far exceed the cost of the original lighting panel or timer.

All known conventional timers and lighting control panels have a switching device positioned between the power into the timer and the power out of the timer. Many conventional digital timers and lighting control panels have a conventional mechanical power relay that functions as the switching device. Such relays will typically be controlled by a conventional microprocessor that incorporates the timing logic. Conventional relays are used because they are inexpensive, reliable and can be selected to have the correct voltage and current rating desired. Conventional relays contemplated by the present disclosure are readily commercially available from numerous suppliers and manufacturers, such as, for example, the Picker PC520, the Omron G5LE, Hasco KLT and Song Chaun 833H brand relays.

There is no known simple timer and/or lighting control panel that has any mechanism that functions to change the lighting level of the controlled fixture(s). All known conventional timers and lighting control panels are limited in function to turning power to the fixture(s) ON and OFF, always with power relays functioning as the power control switch. It is believed that numerous and important advantages could result from using conventional power control relays to control the load circuits for several reasons, as listed below:
1) They are inexpensive;
2) They can completely and safely isolate the timer circuitry from the load lines;
3) In multi-phase electrical systems, they can control power from a phase or phases that is/are different from the phase that is used to power the timer circuit(s);
4) They are commercially available in a wide range of voltage and current ratings, sufficient to meet in many fields of use the needs of timers for use as described herein; and,
5) They are substantially robust and substantially immune from known problems associated with powerline noise and disturbances.

No other attempts to use conventional timer power relays to control multiple lighting levels in lighting fixtures or to control other electrical loads to multiple power settings in an electrical power environment are presently known.

One characteristic of conventional, simple relay based timers and lighting control panels is that they function only to turn the power ON (100%) or OFF (0%) to a fixture, a group of fixtures or to other load(s) on an electrical circuit. There is currently no known method or device or means that enables a conventional, simple power relay to set or otherwise control power to a fixture to set the fixture's lighting level to any level other than ON (at 100% of the fixture's lighting level) or OFF. There is no known means for one conventional, simple relay to set a fixture to 50% lighting level, or to some other lighting level between 0% and 100%. There is no known method for a conventional, simple relay-based timer to meet the multi-level requirements of governmental regulations, such as California Building Standards Code (Title 24) (2013), referred to as Title 24.

Many conventional, complex lighting control systems are known. For example, the DALI brand system incorporates additional low-voltage control wires that must be run to the fixtures to send the level-setting signals to special modules installed in the fixtures. Known disadvantages of know conventional systems, such as the DALI brand system are increased cost of the control circuits, costs to design these systems and costs to run special low-voltage control wires to every fixture to be controlled. Other, additional costs associated with these conventional systems include the costs of, typically, many changes that are needed to be made to the timer printed circuit board (pcb) layout and to the power supplies. Also, often special repeaters must also be installed in order to insure reliable communication between the timer and modules that must be installed in the lighting fixtures, and the additional costs of these repeaters adds to the cost of conventional lighting control systems. For example, a conventional repeater used in these conventional control systems can, in some instances, cost more that the timer itself.

Various, conventional wireless lighting control systems are also known. For example, ZIGBEE and ZWAVE brand wireless control systems incorporate special wireless transmitters and receivers positioned in the timer and in special receiving modules that are positioned in the fixtures. In these conventional systems level-setting signals are transmitted to/from special modules installed in each of the fixtures. Known disadvantages of these systems include increased cost of the transmitting and control circuits that must be incorporated into the timer. There are also other additional costs associated with the timer pcb layout and the power supplies required for these systems. Often special wireless repeaters must be installed in these wireless systems in order to insure reliable communication between the timer and the modules that must be installed in the lighting fixtures. These special wireless repeaters can, in some instances cost more that the timer itself, thus contributing to the relatively high cost of conventional wireless light level control systems.

In addition, other conventional lighting control systems have complex powerline communications such as PulseWorx® and SimpleWorx® brand systems commercially available from by Powerline Control Systems, Inc., and Insteon® brand system commercially available from Smart Home. These conventional systems are also capable of changing the lighting level in lighting fixtures. These conventional systems also have cost-related disadvantages associated with the timer pcb layout and the power supplies. Also, in some applications of these systems, special powerline communication repeaters must be installed in order to insure reliable communication between the timer and the modules that must be installed in the lighting fixtures. These repeaters can, in some instances, cost more that the timer itself.

### Objects and Advantages of the Presently Described Systems and Processes

With reference to the above Background, several objects and advantages of the presently described systems, apparatuses and processes include:
Providing a method whereby conventional wall box timers or lighting control panels can meet the multi-level lighting requirements of California Title 24 Standards;
Providing a method whereby conventional wall box timers or lighting control panels are adapted to control lighting loads to any of multiple levels lighting output without additional cost to the hardware components or to assembly costs of conventional wall box timers and lighting control panels;
Providing a method of sending messages to relatively small, inexpensive 0-10V receiving modules, which modules can be installed in lighting fixtures when and as needed;
Providing a method of sending messages through conventional, electrically held contactors to relatively small, inexpensive 0-10V receiving modules, which modules can be installed in lighting fixtures connected to said contactors when and as needed;
Providing a method of sending messages through conventional latching contactors to relatively small, inexpensive 0-10V receiving modules, which modules that can be installed in lighting fixtures connected to said contactors when and as needed;
Providing simple receiving modules that can be installed in any fixture using conventional 0-10V ballasts or 0-10V drivers when and as needed;
Providing a method of lighting control using conventional, simple receiving modules that do not need to incorporate any line voltage primary control;
Providing a method of lighting control using conventional, simple receiving modules that do not need to incorporate any line voltage primary control and that can be installed in, and function to control any conventional fixture using conventional 0-10V ballasts or LED drivers;
Providing wall box timers and/or lighting control panels that can be used to control or establish any of multiple lighting levels in light fixtures when and as needed, with the wall box timers and/or lighting control panels installed and wired as are other conventional wall box timers or lighting control panels, and with no additional associated design or wiring expense;
Providing wall box timers and/or lighting control panels capable of controlling lighting fixtures to any of multiple lighting levels, while retaining the conventional capability to turn fixtures ON and OFF in the absence of special receiving modules installed in said fixtures; and,
Provide wall box timers and/or lighting control panels capable of controlling lighting fixtures to any of multiple lighting levels, while retaining the conventional capability to turn fixtures ON and OFF in the absence of said fixtures incorporating 0-10V dimming ballasts or LED drivers.

New energy saving regulations such as found in California Title 24 mandate that certain lighting loads must be able to be set to any of several different levels at different times to save energy. For example, some outdoor fixtures must be capable of being set to about 50% of full light output at certain times. The following excerpt is taken directly from California Title 24, “Nonresidential Building Energy Efficiency Standards” that went into effect in July 2015. The bolded and underlined wording emphasize a requirement that an intermediate lighting level, usually between 40% and 80% of the full light level must be achievable in order to comply with Title 24.

Summary of Changes in 2013 Title 24 Standards

Mandatory Changes
All luminaires rated for use with lamps greater than 141 watts shall comply with the uplight and glare maximum zonal lumen limits.
All outdoor lighting shall be controlled both by a photocontrol device and by an automatic scheduling control. This is a change from 2008, when only a photocontrol was required. An astronomical time-switch control that automatically turns the lights off during daylight hours is allowed as an alternative to a photocontrol device. All outdoor lighting is required to be circuited and independently controlled from other electric loads.
Outdoor luminaires mounted less than 24 feet above the ground are required to have controls (motion sensors or other systems) that are capable of reducing the lighting power of each luminaire by at least 40 percent but not exceeding 80 percent. The luminaire must switch to its “on” state automatically when the space becomes occupied.
In addition to the photocontrol and automatic scheduling controls described above, outdoor sales frontage, outdoor sales lots, and outdoor sales canopy lighting, controls are required that offer part-night control or have motion sensing capability to automatically reduce the lighting power by at least 40 percent but not more than 80 percent, and ability to automatically turn the lighting to ‘occupied’ light level when the space becomes occupied.
For building façade, ornamental hardscape, and outdoor dining, the same additional controls are required as for outdoor sales areas (above), but a centralized time-based zone lighting control that reduces lighting power by at least 41 percent is allowed as an alternative.

### SUMMARY OF INVENTION

In order to aid in understanding, the presently disclosed systems and methods are specialized power control systems, apparatuses, circuits and methods that function to operate conventional power control relays for them to send specialized signals to downstream lighting devices and cause changes to different lighting levels, and, in more general uses, to send specialized signals to downstream electrical loads such as fans, heater and motors, to cause changes in the operation of those loads, such as changes is air flow, heat output and motor speed, respectively.

Also described is a specialized transmitting device in the form of a wall-box timer or lighting control panel connected to one or more phases of a conventional power system using said method to operate conventional power control relays to send signals to downstream lighting devices such as LED fixtures, connected to the power circuit controlled by said relays and effect changes to different lighting levels in said downstream lighting devices such as LED fixtures.

An additional embodiment of the control method is one where said signals are designed so that said signals will be passed through conventional lighting contactors to lighting loads attached to said contactors.

Also described is a specialized receiving device connected to the power circuit controlled by said relays capable of receiving said signals and setting the lighting level of 0-10V equipped lighting fixtures.

Also described is a specialized LED driver capable of receiving said signals and setting the LED lighting level utilizing the method described in this invention. In this embodiment of the invention the receiving method is embedded within said LED driver.

Also described is a specialized LED driver integrated circuit (IC) capable of receiving said signals and setting the LED lighting level utilizing the method described in this invention. In this embodiment of the invention the receiving method is embedded within said LED driver Integrated Circuit (IC).

Also described is a method of using power relay output circuits with conventional drive circuit components also as user definable input control circuits, typically connected to occupancy sensors or remote switches.

These embodiments or parts of the embodiments can be listed as:
1. Power Relay Lighting Level Control Method
2. Transmitting Device is a Wall Box Timer
3. Transmitting Device is a Lighting Control Panel
4. Transmitting through Contactors
5. Receiving Device Module
6. Receiving Embedded in LED Driver
7. Receiving Embedded in LED Driver Integrated Circuit (IC)
8. Power Relay as Optional Input

These several innovations covered in the application are described more thoroughly below.

1) Power Relay Level Control Method
A method by which conventional wall-box timers or lighting control panels or any other device that controls line-voltage power using mechanical relays can also use the same power control relays to send level setting messages to simple inexpensive receiving modules installed in fixtures that are connected on the circuits that are powered by those relays.

2) Transmitting Device is a Wall Box Timer
A conventional wall-box timer where the timer has incorporated the transmitting control method described in this invention. This embodiment of the invention does not require any receiving modules to be installed as part of the system because the receiving modules can be installed at any later time as an option.

3) Transmitting Device is a Lighting Control Panel
A conventional Lighting Control Panel where the timer has incorporated the transmitting control method described in this invention. This embodiment of the invention does not require any receiving modules to be installed as part of the system because the receiving modules can be installed at any later time as an option.

4) Transmitting Through Contactors
A method by which conventional wall-box timers or lighting control panels or any other device that controls line-voltage power using mechanical relays can also use the same power control relays to send level setting messages to simple inexpensive receiving modules installed in fixtures that are connected to contactors on the circuits where the coils of the contactors are powered by those relays. Powerline messages are designed so that they will be successfully transmitted through secondary lighting contactors if such contactors are installed and said messages will reach receiving modules installed in fixtures attached downstream of the contactors

5) Receiving Device Module
Simple receiver module that can control the lighting level of a lighting fixture when connected to circuits controlled by relays incorporating the method of this invention. The receiving module requires NO primary ON/OFF power control relay inside the receiver module because the primary ON/OFF control to the lighting fixture(s) is controlled by the relays installed in the timer or lighting control panels.

6) Receiving Embedded in LED Driver
This embodiment of the invention is in the form of a LED driver where the method of this invention is in the form of a receiver is embedded into the internal circuits and logic of the LED driver. This produces an extremely cost effective solution taking advantage of the driver power supply, enclosure, connections and microprocessor thereby reducing the incremental cost to produce lighting level control to almost zero.

7) Receiving Embedded in LED Driver Integrated Circuit (IC)
This embodiment of the invention is in the form of a LED driver where the method of this invention is in the form of a receiver is embedded into the internal circuits and logic of the LED driver Integrated Circuit. This produces an extremely cost effective solution taking advantage of the driver power supply, enclosure, connections and microprocessor thereby reducing the incremental cost to produce lighting level control to almost zero.

8) Power Relay as Optional Input
The same exact power connections that are used for timer connections to power fixtures can also optionally be used as inputs from occupancy sensors or remote switches through only one sensing line which is also used to sense AC line zero crossing for use to protect the relay contacts by opening and closing the relay at the zero crossing points.

The first basic concept is that the exact same relays that are inside of the control device, which is typically in the form of a conventional wall box timer or lighting control panel, are used not only to turn the loads on and off, but are also used to control the lighting loads to different levels.

The method used to accomplish this is to use the power control relays also as transmitters to send messages to the special receiving modules installed in the lighting fixtures. The messages used in the preferred embodiment of this application consist of a few short opening and closing of the power relay in a certain predetermined pattern. The relays can be operated to produce the pattern very quickly such that the disturbance on the power line does not have any noticeable effect on the lighting fixtures. Testing has shown that the power supplies and drivers used on modern LED and florescent fixtures do not exhibit any flickering or other negative effects from the short disturbances used in our special form of communication.

Another part of the system is small receiving modules that must be installed in the fixtures if the multiple light levels are to be achieved. The receiving modules typically have standard 0-10 VDC outputs that care connected to conventional 0-10 VDC control inputs of conventional dimming ballasts or dimming LED drivers. Because of the simplicity and small size these receiving modules can be very small and inexpensive. One key benefit of this innovation is that the power relay that controls primary power from the trimer to the lighting fixture is still in the system, and in the timer, and still performs the function of turning ON and OFF the power to the lighting fixtures. This is important for two reasons. One, the power relays are already part of all conventional timer designs, so no change is necessary in the timers and lighting control panels . And, two, because to OFF function is supplied by the power relay in the timer, then NO ADDITIONAL PRIMARY POWER CONTROL RELAY IS NECESSARY IN THE RECEIVING MODULES. Other control modules used in wireless, hard-wired, or powerline communication systems MUST HAVE PRIMARY POWER RELAYS or other switching devices in the receiving modules that are capable of turning the power ON and OFF to the lighting fixture. The small receiving modules that are part of the current invention do not need to supply the primary ON and OFF functionality since that functionality is still provided by the power relays installed in the timer.

One significant value of this system is that the wall-box timer or lighting control panel is wired exactly as any other conventional wall-box timer or lighting control panel. There are one or more relay outputs available on a connector so that the loads to be controlled are wired directly to the connector. Since the contacts of these relays are isolated from the rest of the circuitry the electrician can safely connect each circuit output to any phase of a two or three phase system. Each circuit is connected to either a Normally Closed or Normally Open contact and also to a Common Contact. The logic and electronics of the timer simply open and close these relays according to some desired functionality. This functionality is usually some form of timing functionality.

Adding the ability for the same ON/OFF relays to also be able to change the lighting level in the fixtures is extremely valuable. There are new regulatory requirements that mandate that certain fixtures be capable of being set to 100% 50% and Off. There is currently no simple relay-based timer that can accomplish this functionality.

There are many ways that complex, expensive, sophisticated, powerline communicating or wireless systems can accomplish this goal. The method of this invention requires ABSOLUTELY NO change in the hardware or assembly cost of a typical wall-box timer or lighting control panel. The only change is in the microprocessor firmware to operate the relays in an appropriate predetermined pattern in order to send a signal down the power wiring to the lighting loads. Therefore the cost to add this functionality to existing timers or lighting panels is almost zero.

It is true that small inexpensive modules need to be installed in the dimmable lighting fixtures in order to complete the functionality, but this step does not need to be completed unless the user chooses to complete the multi-level functionality. The value is that the timer or lighting control panel can be installed exactly as any conventional timer or lighting control panel without any additional design or programming or thinking, and the multi-level functionality which may be deemed to be necessary at a later time, if fully available at a very small cost.

With complex powerline communicating or wireless systems this goal could be accomplished but the user would have to remove the conventional timer and install an expensive new powerline communicating or wireless timer in its place. It is much better just to install our simple timer and add the functionality later if desired. There need be NO wiring or design changes, except adding the small 0-10V output module to the fixtures.

Embodiments, examples, features, aspects, and advantages of the present disclosure will become better understood with regard to the following description, appended claims and accompanying drawings.

### BRIEF DESCRIPTION OF THE DRAWINGS

The foregoing aspects and the attendant aspects of the present disclosure will become more readily appreciated by reference to the following detailed description, when taken in conjunction with the accompanying drawings, wherein:

FIG. 1 TYPICAL TIMER WIRING This figure shows the wiring diagram of any typical wall box timer including a timer that would be used as the timer incorporating the new functionality of the current application. This figure also shows the circuit breaker panel supplying power to the time and two typical lighting fixtures controlled by the timer.

FIG. 2 TIMER WITH RELAY SHOWN This figure shows the wiring diagram of any typical wall box timer including an expanded view of the power relay installed within the timer. This figure also shows the circuit breaker panel supplying power to the time and two typical lighting fixtures controlled by the timer. Inside the lighting fixtures are shown the ballasts or drivers that power the light bulbs or LEDs.

FIG. 3 TIMER WIRING WITH 0-10V CONTROL MODULES INSTALLED IN FIXTURES. This figure shows the wiring diagram of any typical wall box timer including a timer that would be used as the timer incorporating the new functionality of the current application. This figure also shows the circuit breaker panel supplying power to the time and two typical lighting fixtures controlled by the timer. Inside the lighting fixtures are shown the ballasts or drivers that power the light bulbs or LEDs and the special receiving modules that provided the multi-level control to the ballast/driver 0-10V input wires.

FIG. 4 8 CHANNEL LIGHTING PANEL WIRING WITH 0-10V CONTROL MODULES INSTALLED IN FIXTURES. This figure shows the wiring diagram of any typical wall box timer including a timer that would be used as the timer incorporating the new functionality of the current application. This figure also shows the circuit breaker panel supplying power to the time and two typical lighting fixtures controlled by the timer. Inside the lighting fixtures are shown the ballasts or drivers that power the light bulbs or LEDs and the special receiving modules that provided the multi-level control to the ballast/driver 0-10V input wires.

FIG. 5 LIGHTING FIXTURE WIRING WITH 0-10V CONTROL MODULES INSTALLED. This figure shows the wiring diagram of the typical lighting fixtures controlled by the timer. Inside the lighting fixtures are shown the ballasts or drivers that power the light bulbs or LEDs and the special receiving modules that provided the multi-level control to the ballast/driver 0-10V input wires.

FIG. 6 0-10V CONTROL MODULES WITH AND WITHOUT PRIMARY CONTROL One key benefit of this innovation is that the power relay, 19, in the timer that controls primary power from the timer to the lighting fixture, is part of the system, and in the timer this relay still performs the function of turning ON and OFF the power to the lighting fixtures. This is important for two reasons.

One, the power relays are already part of all conventional timer designs, so no change is necessary in the timers and lighting control panels.

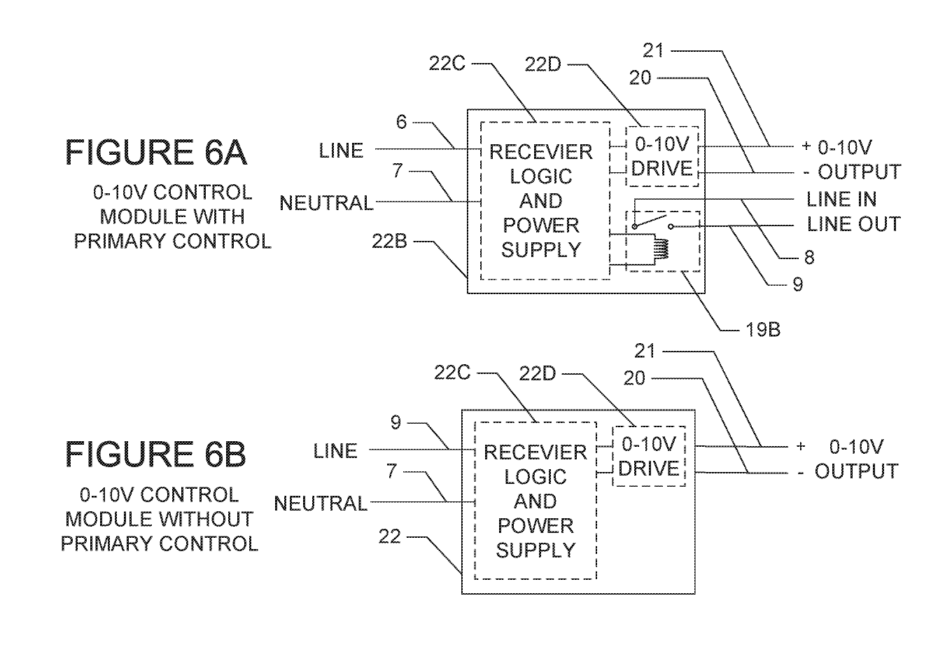

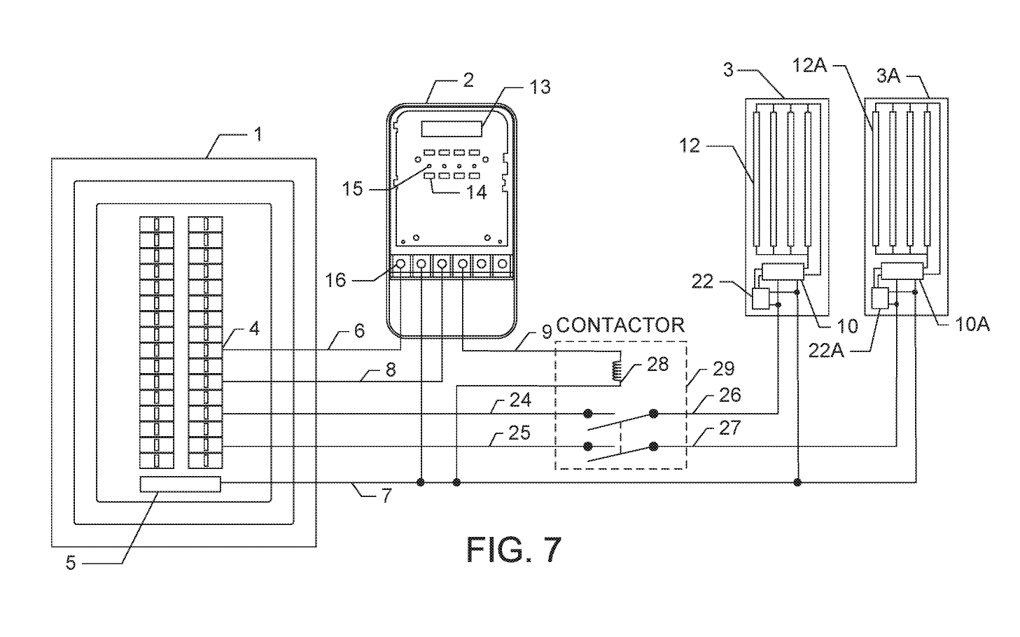

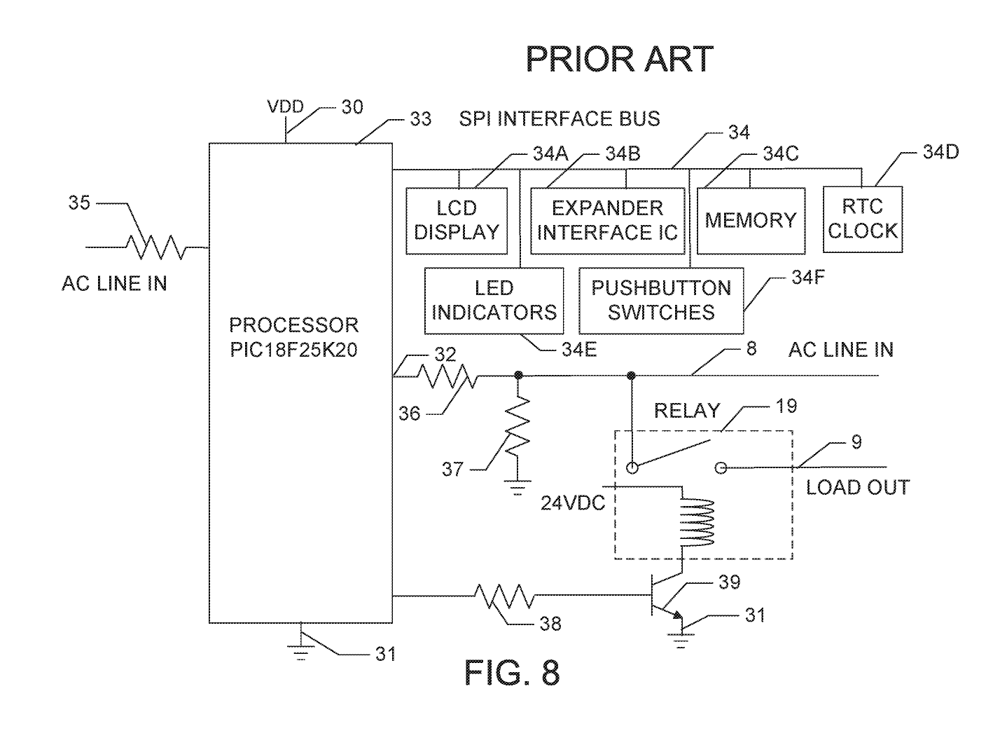

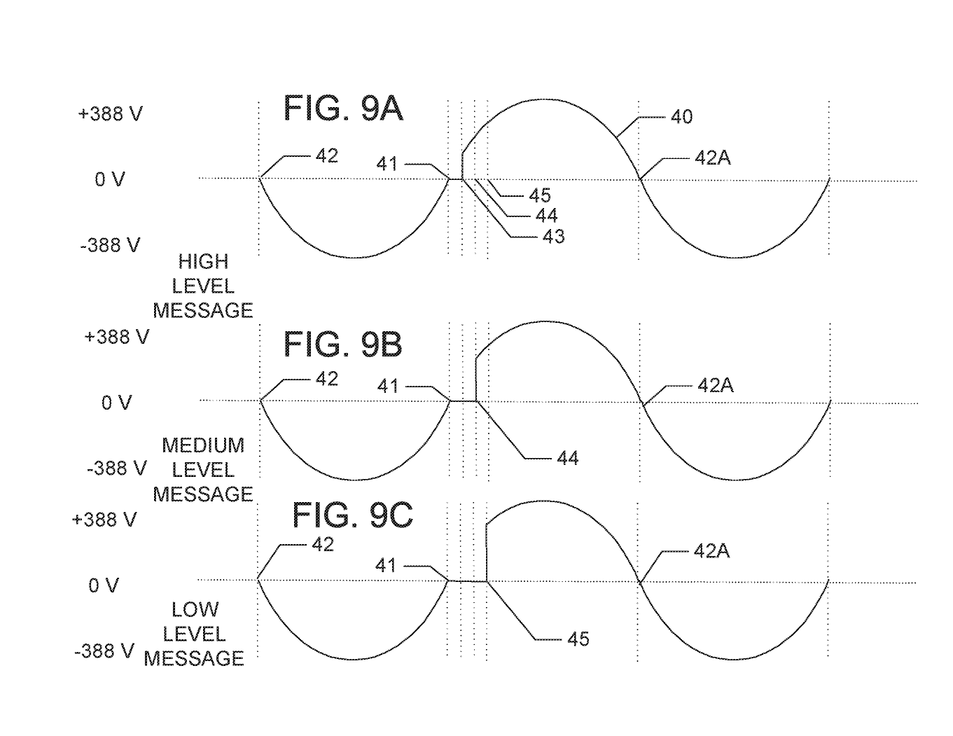

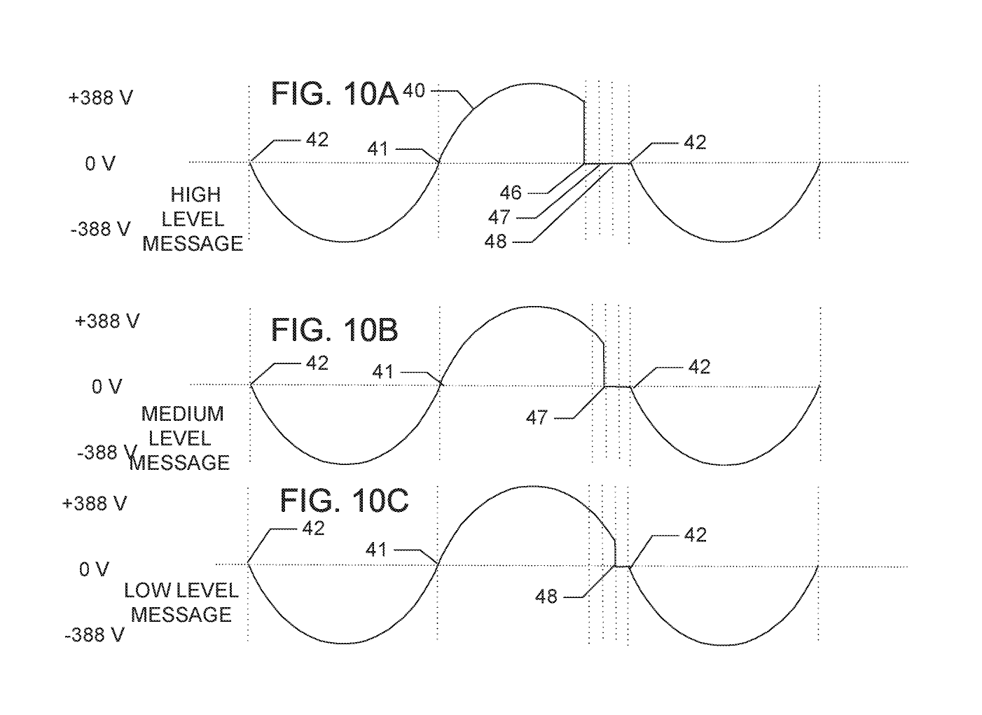

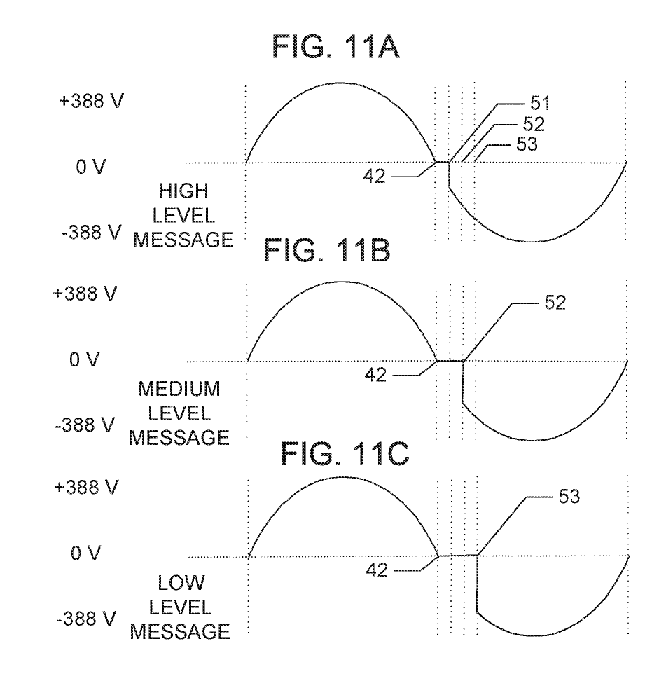

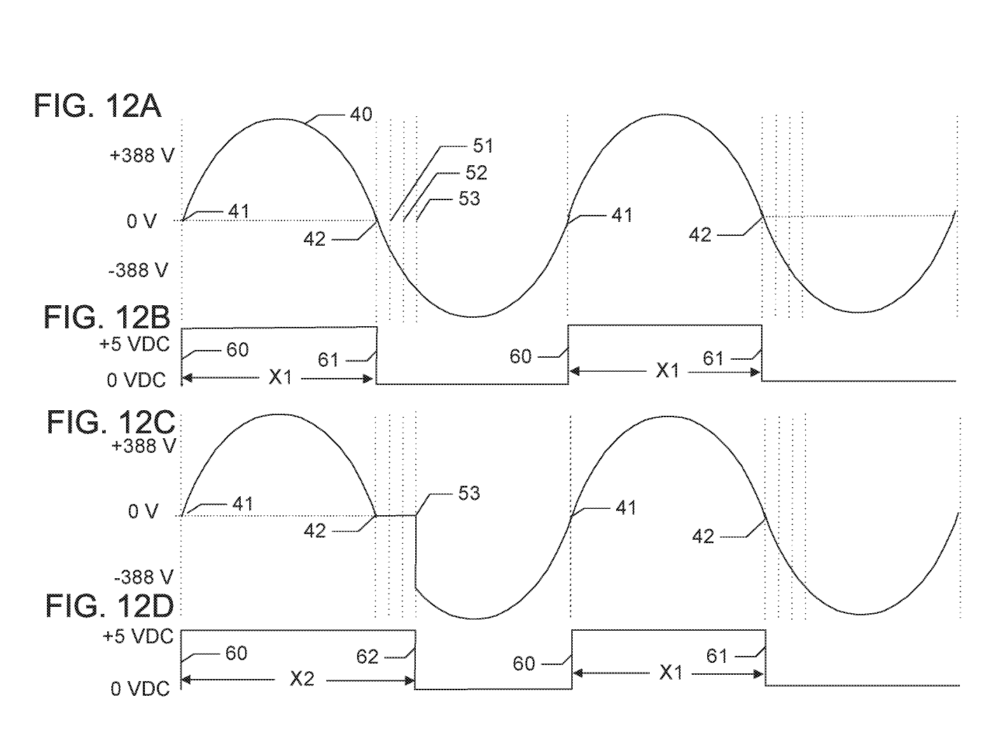

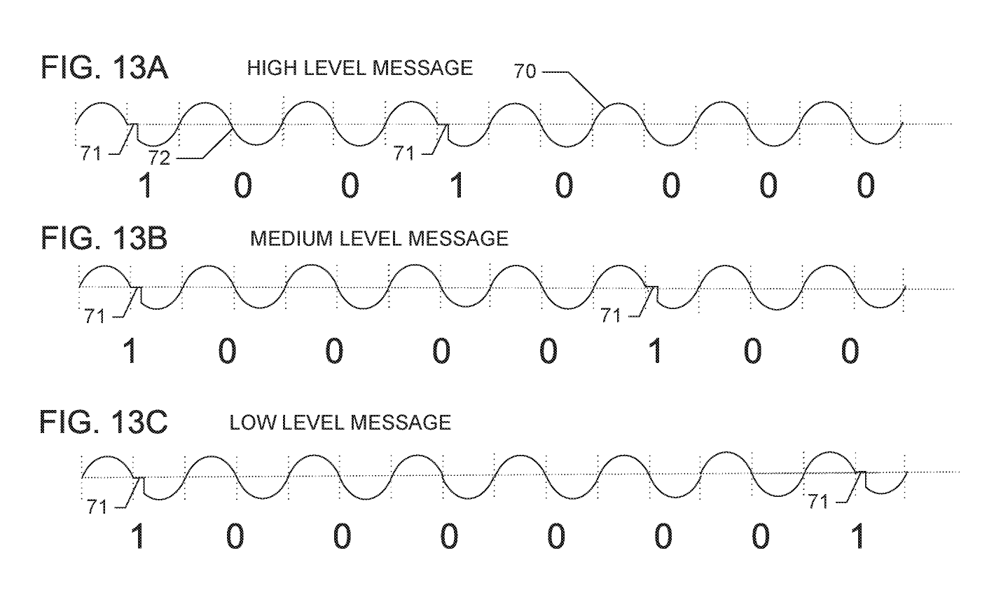

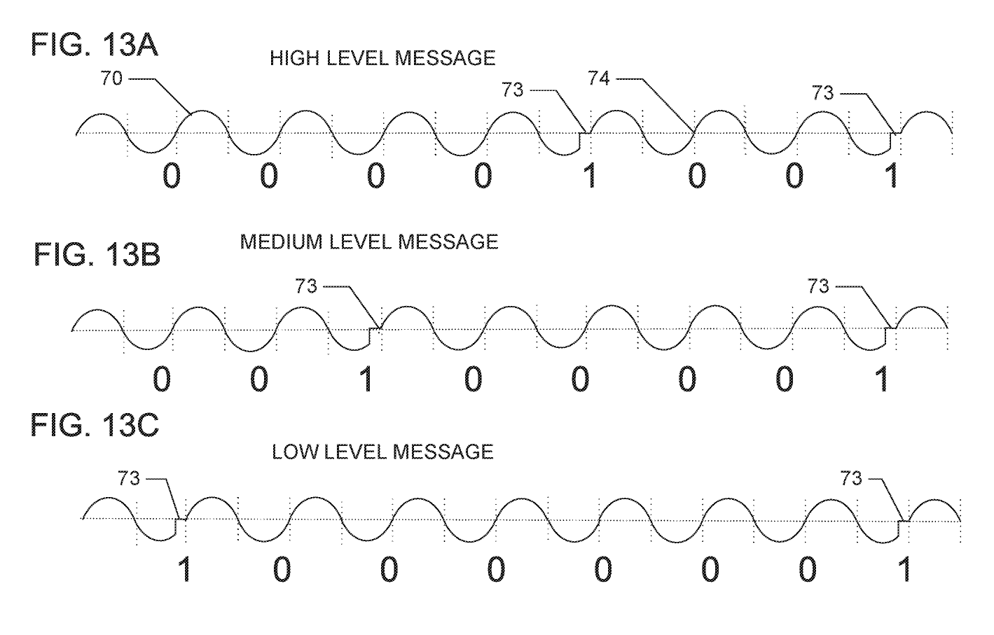

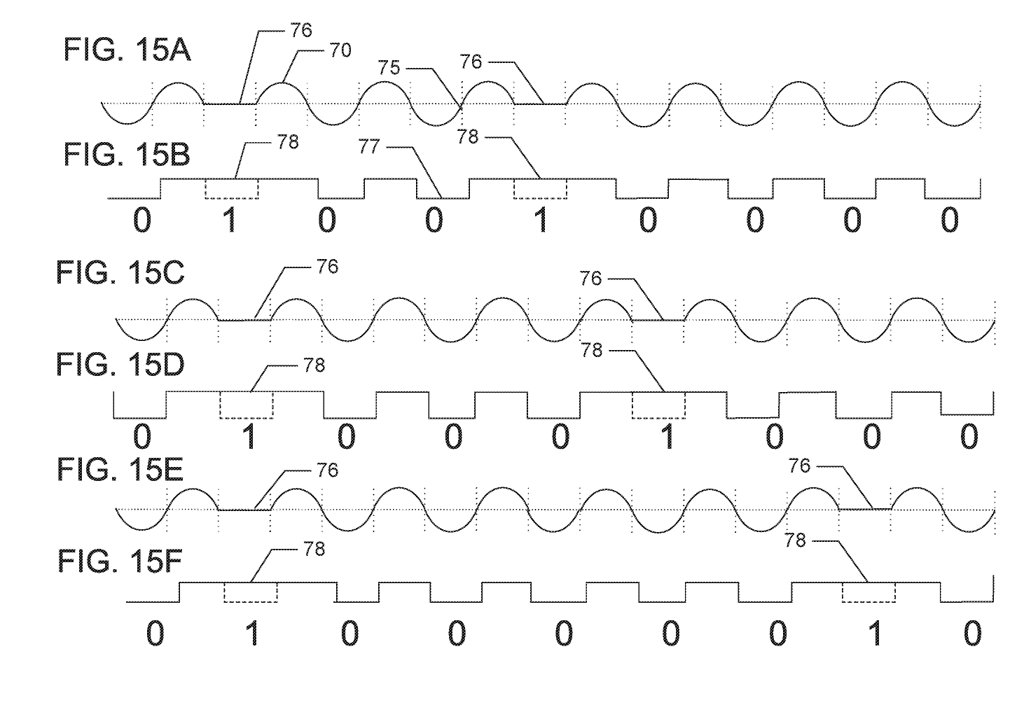

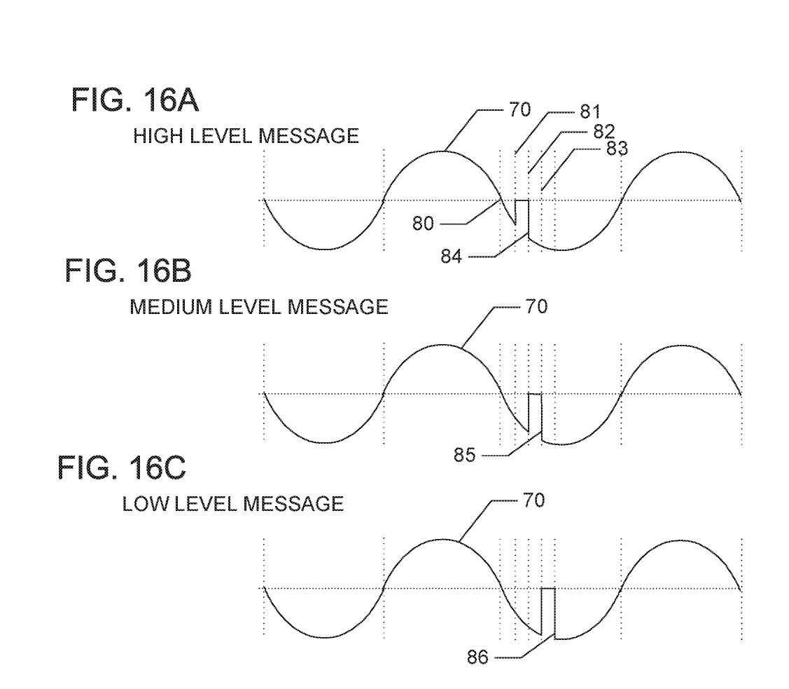

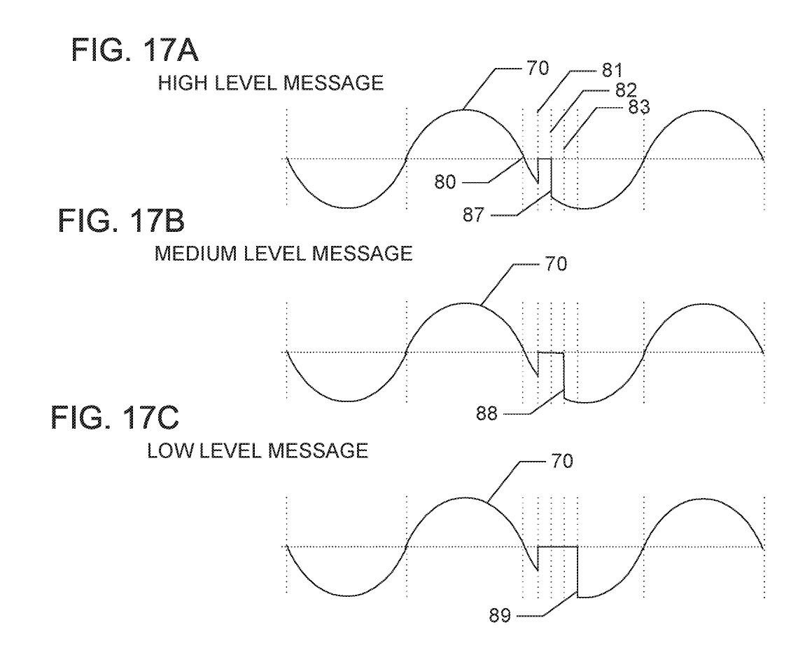

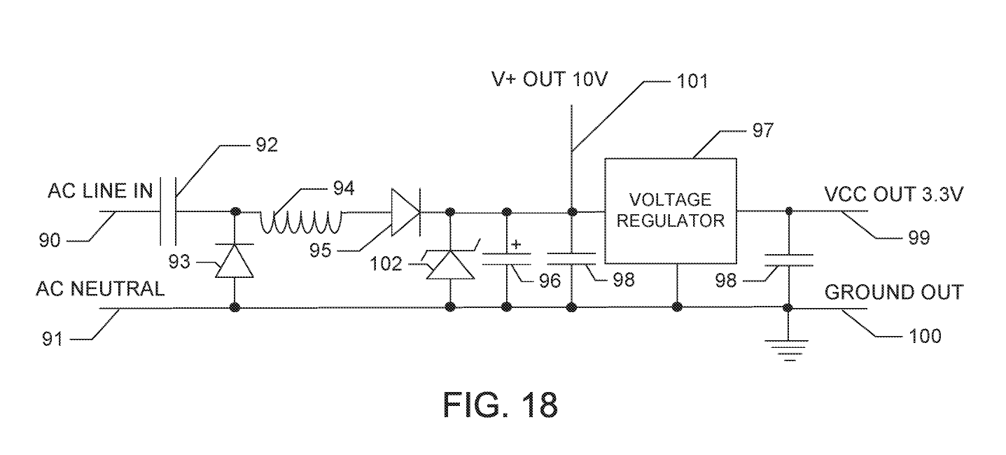

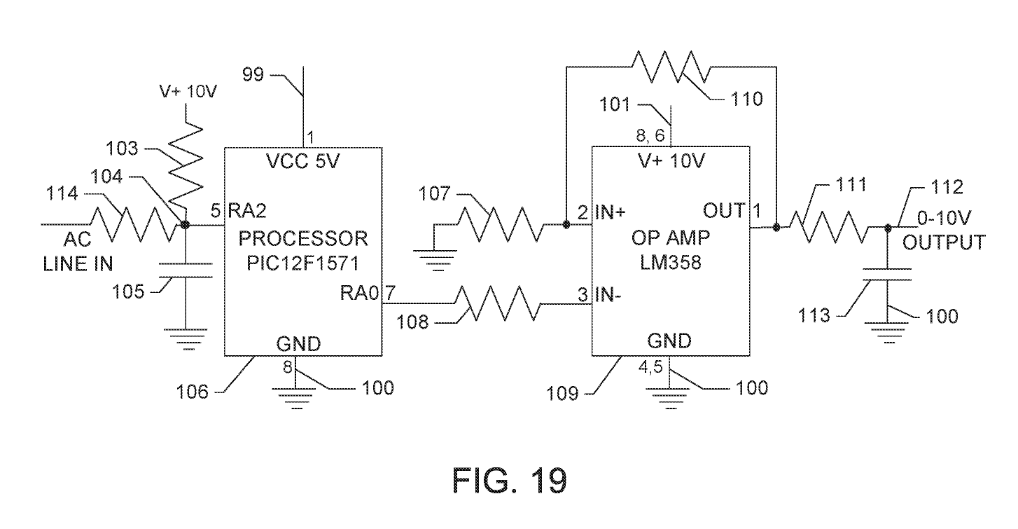

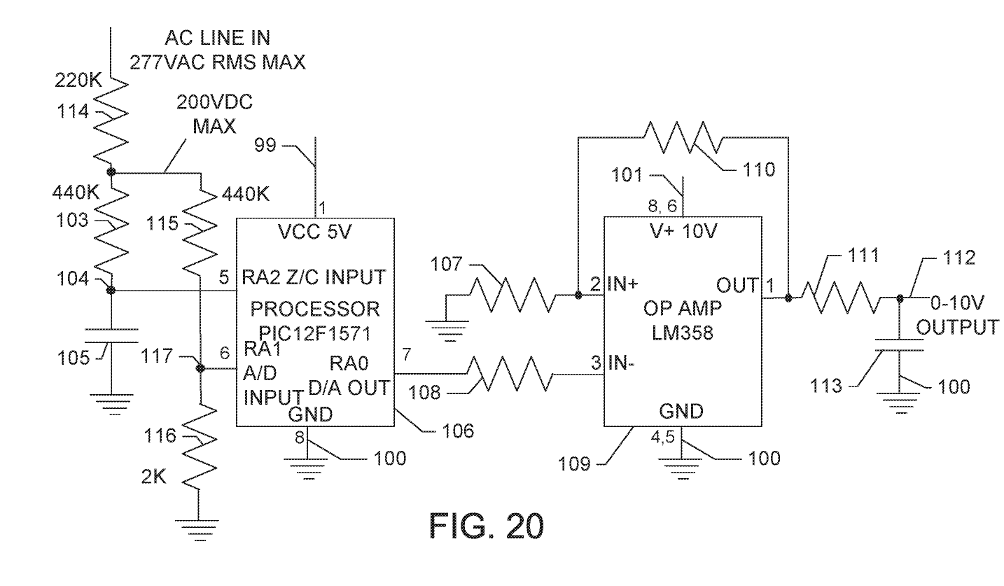

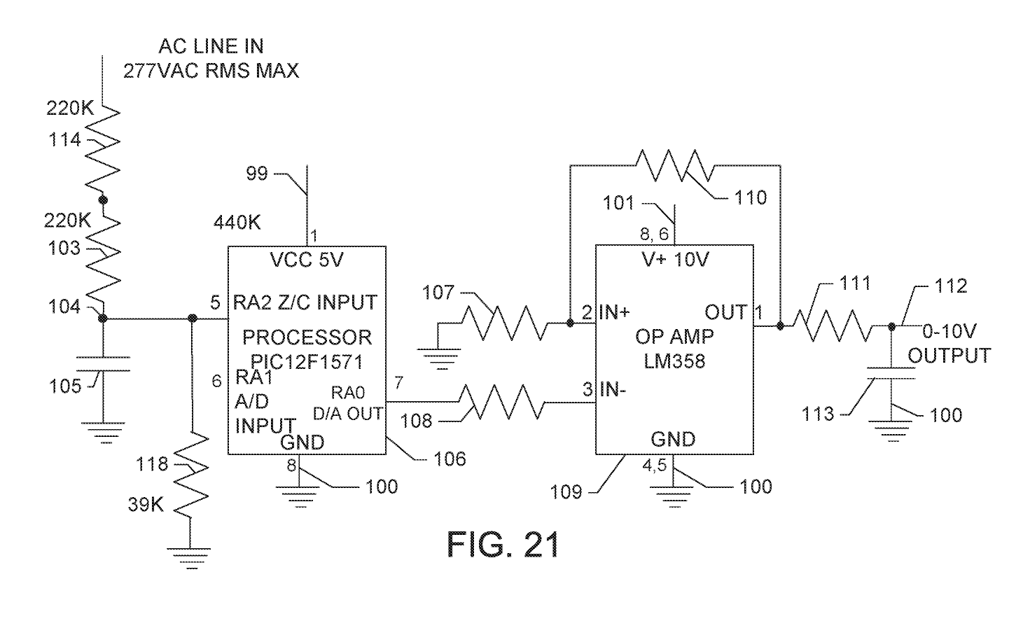

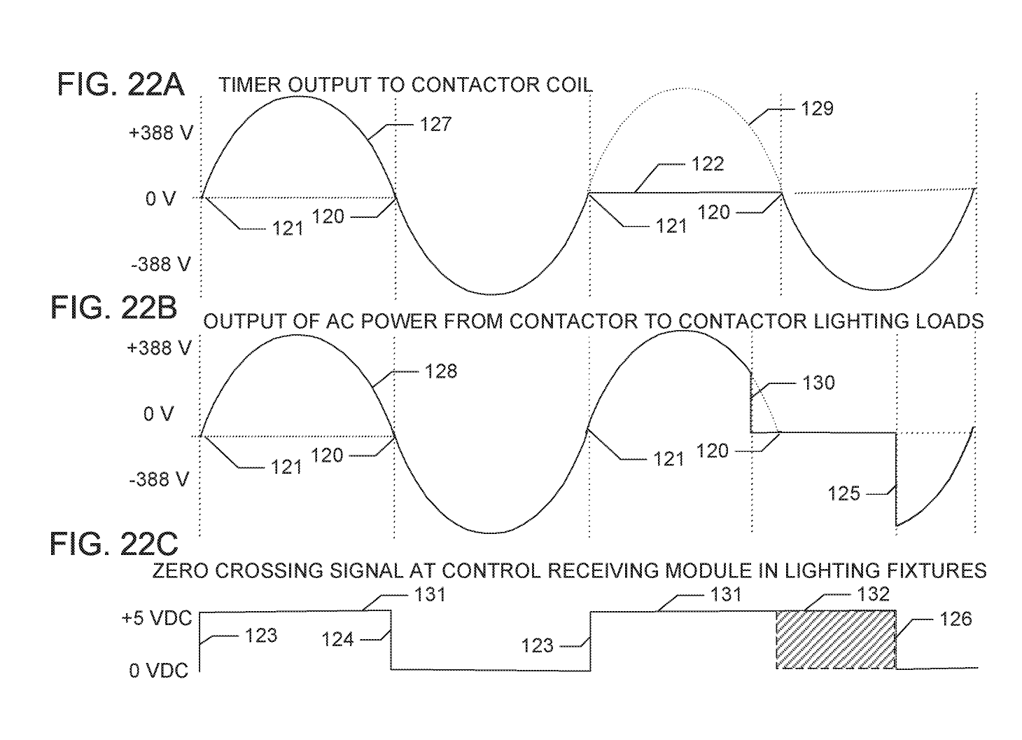

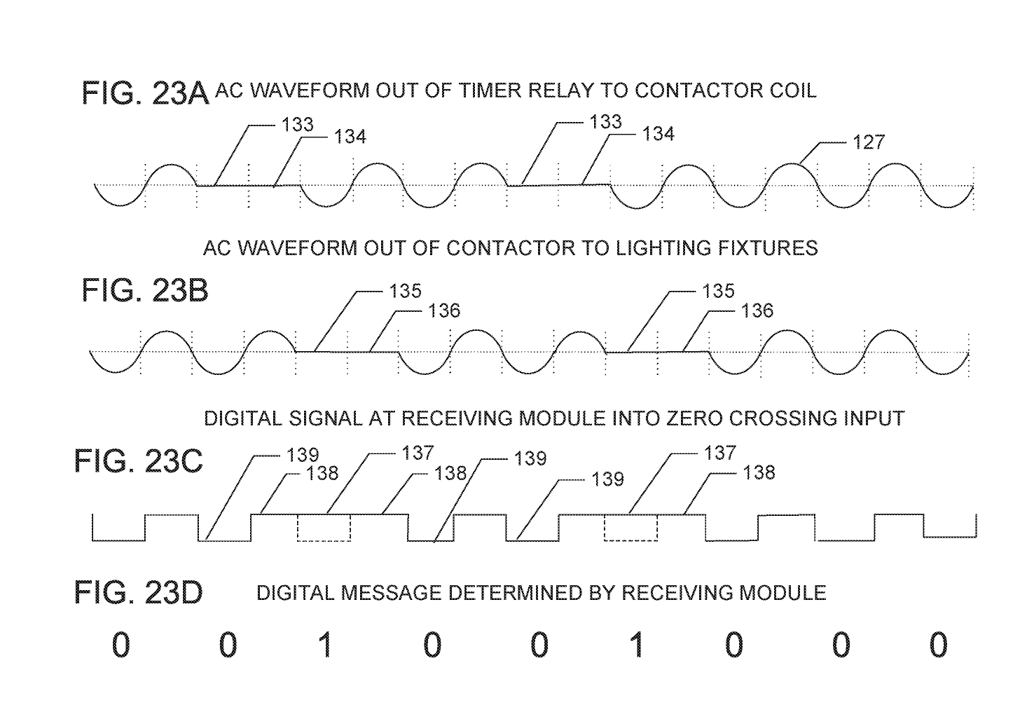

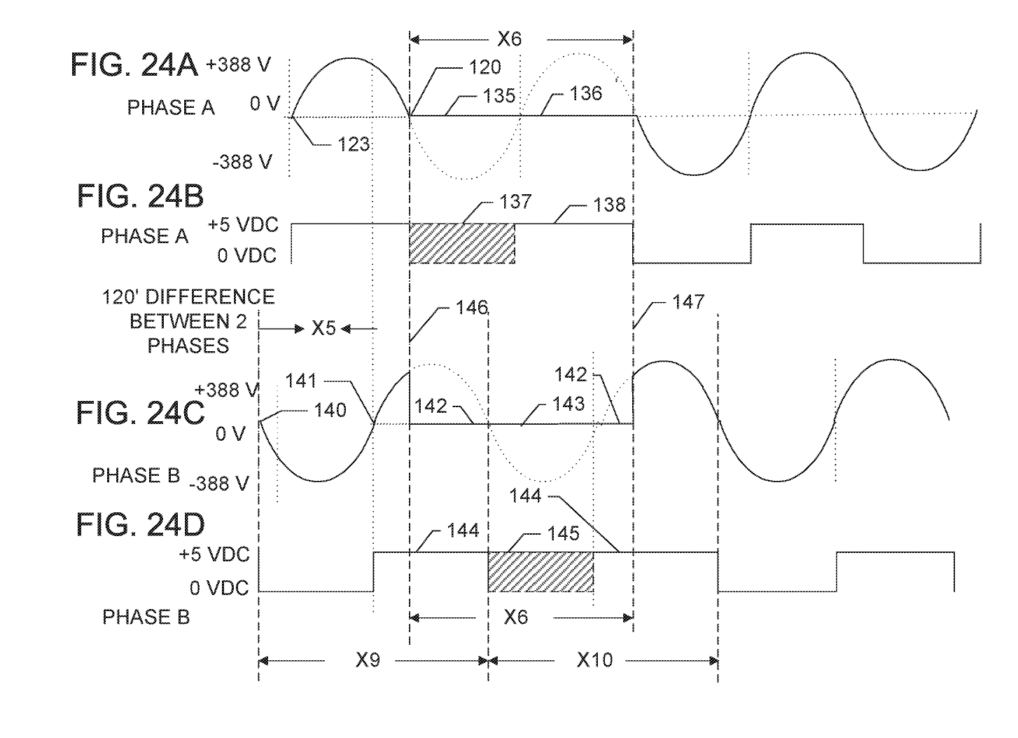

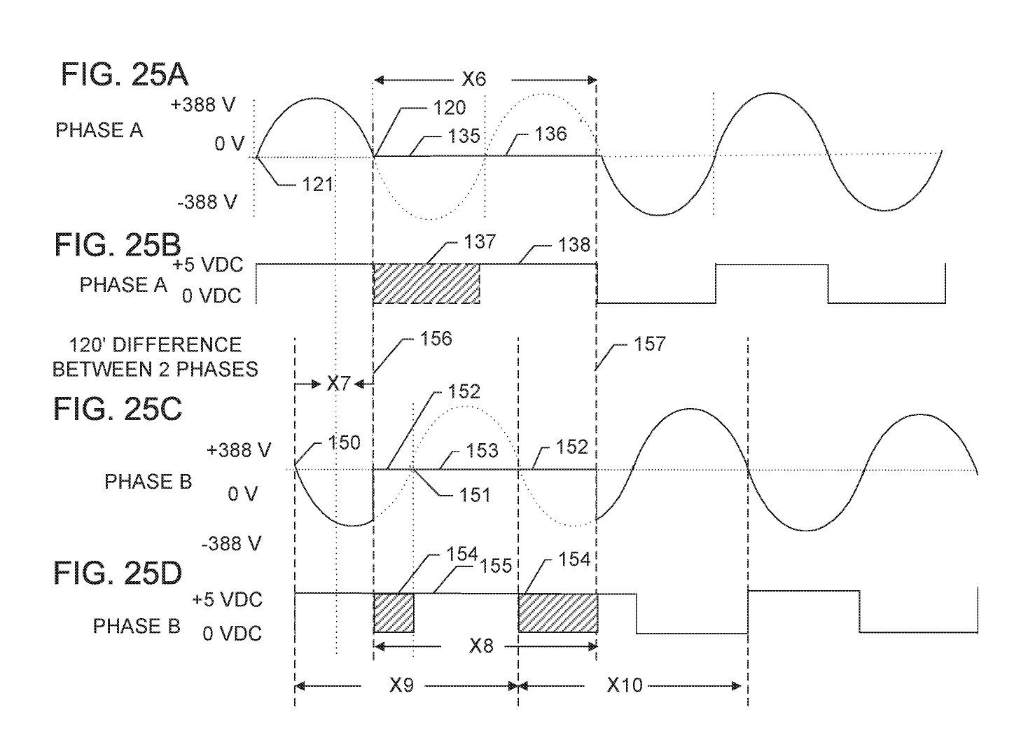

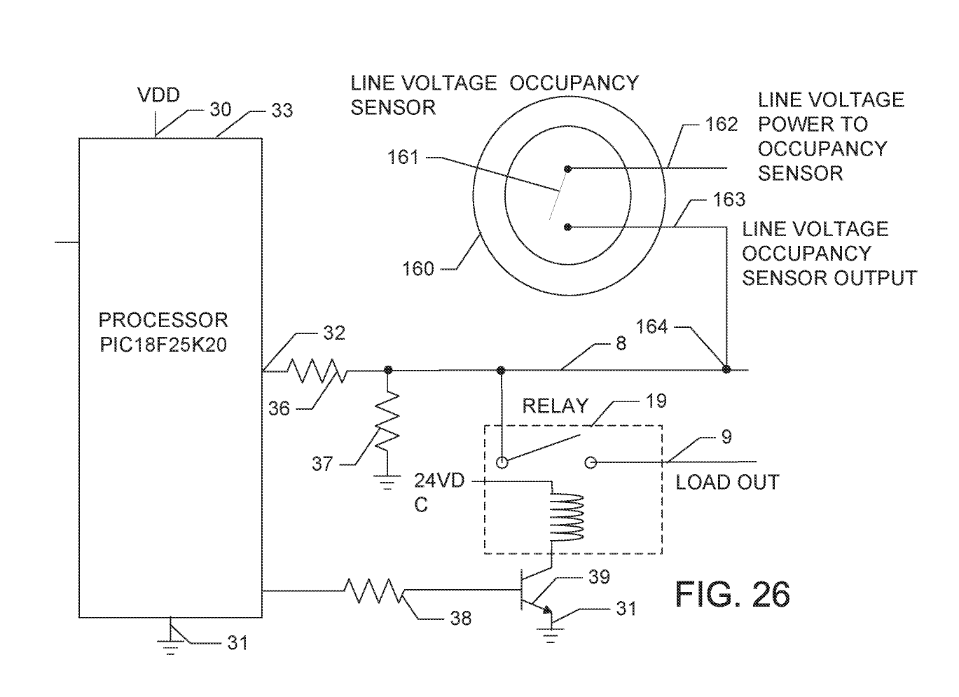

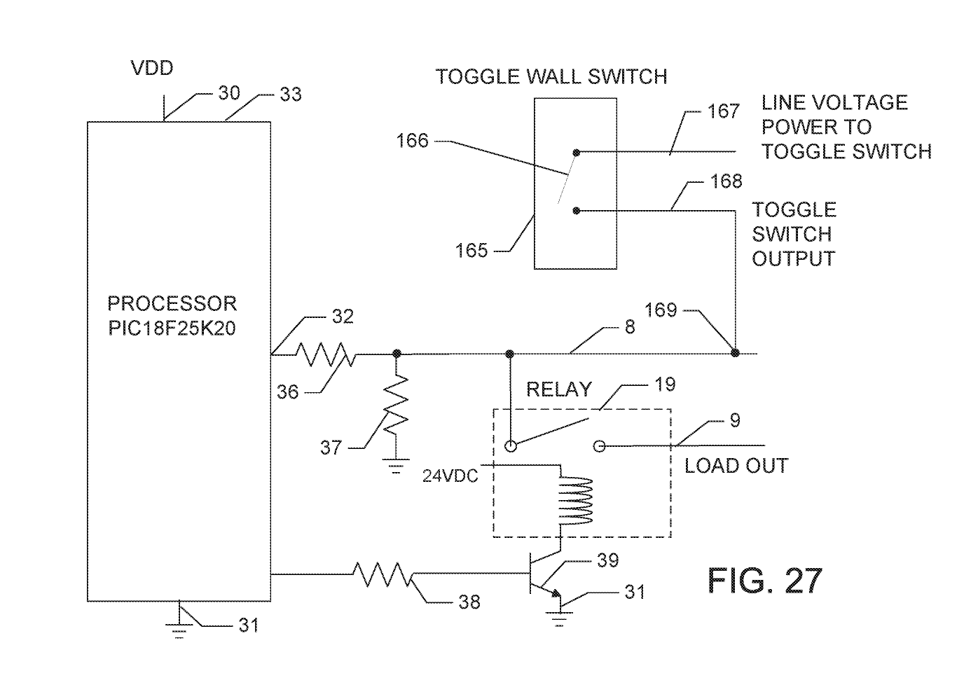

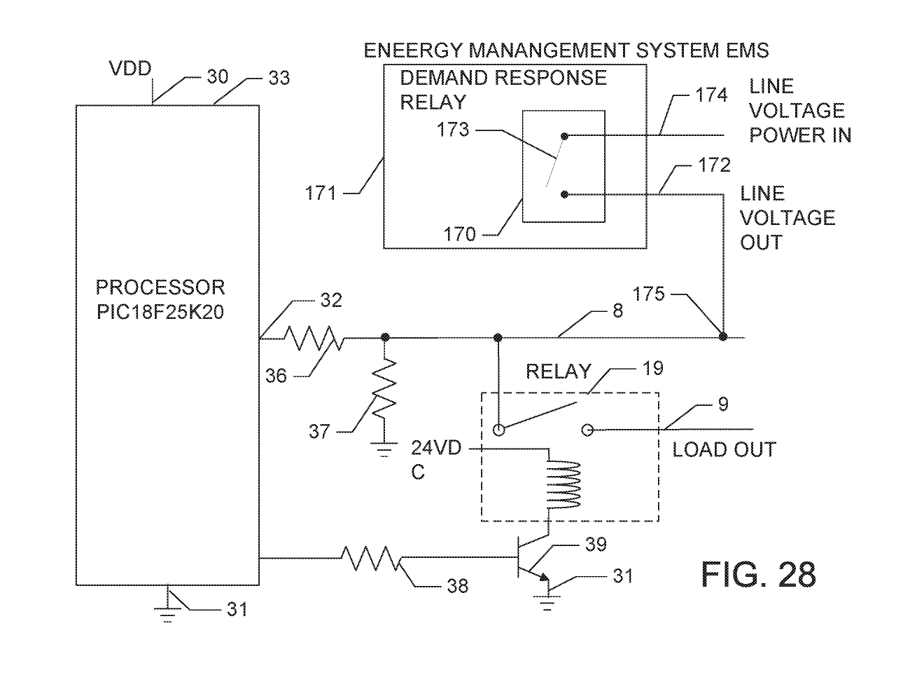

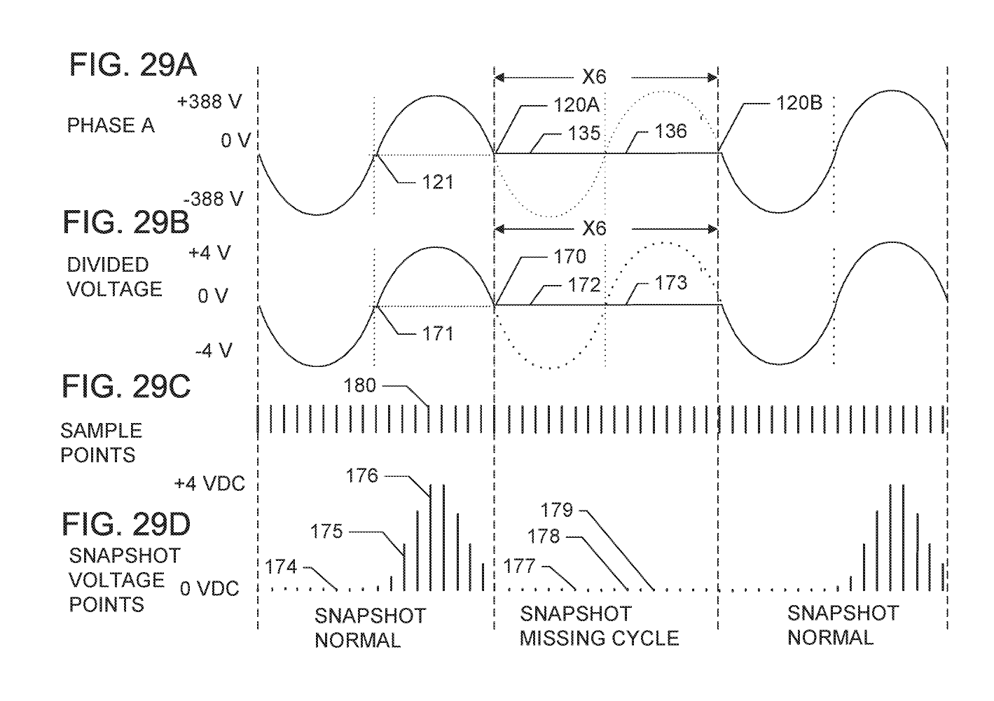

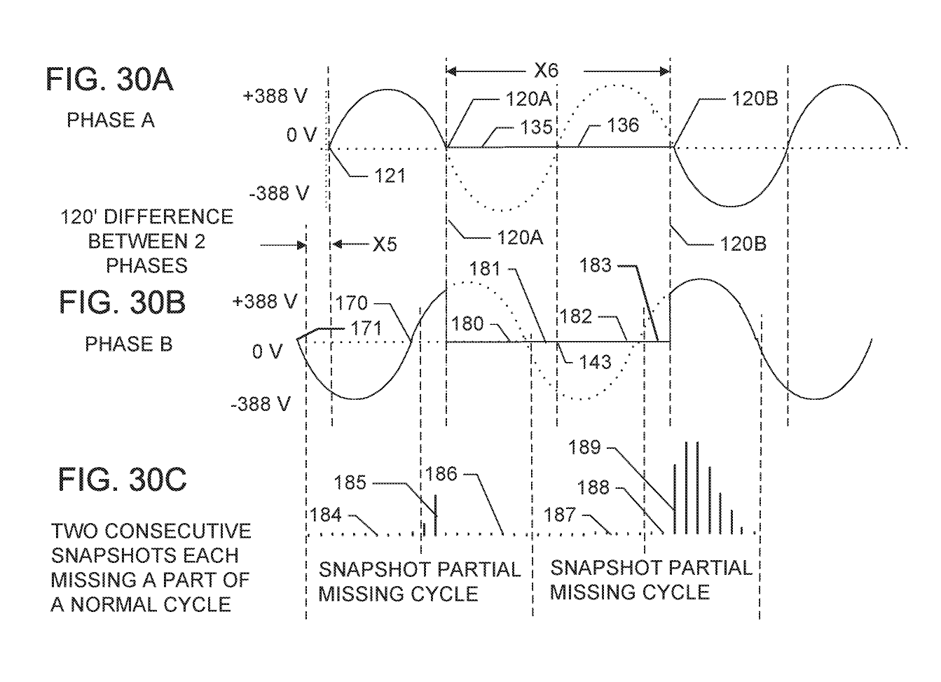

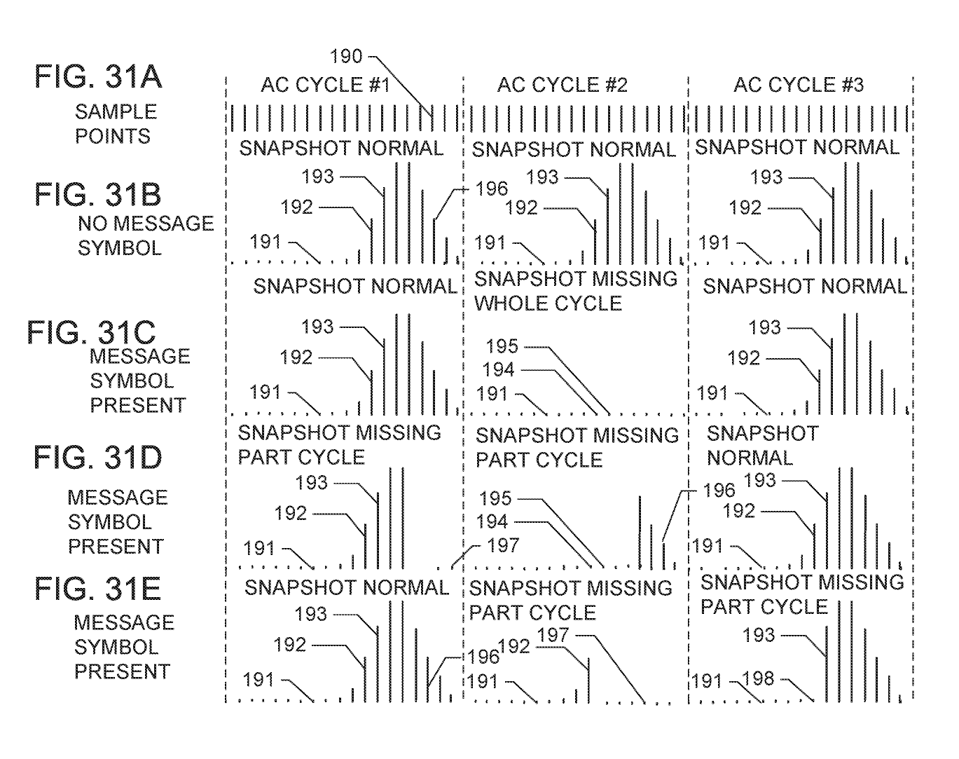

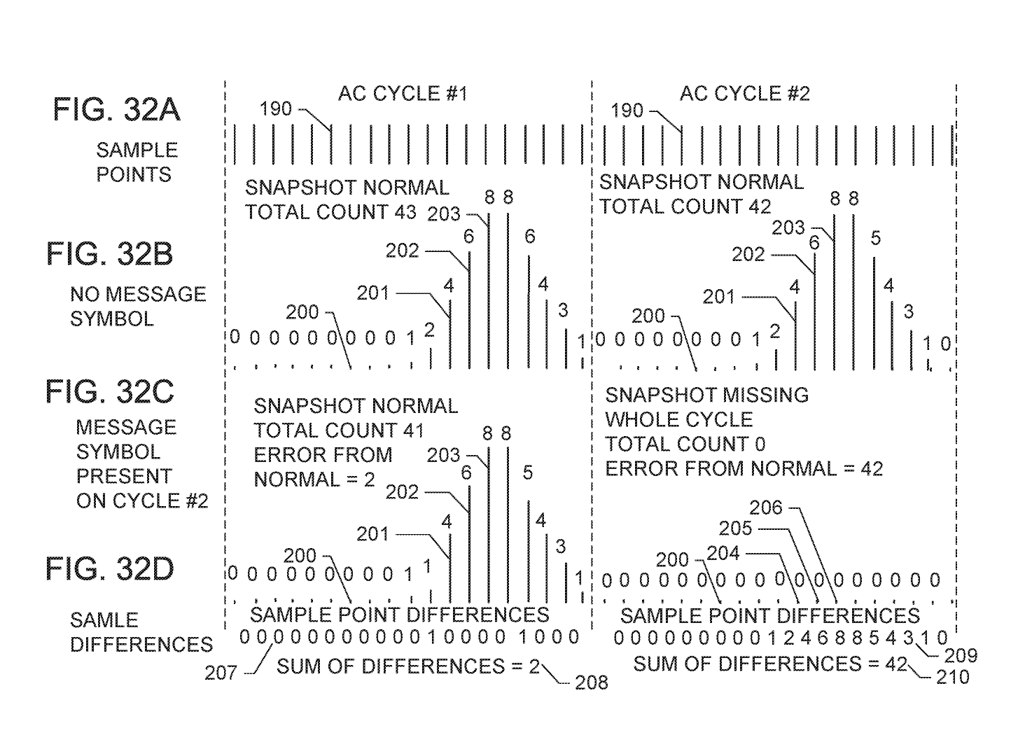

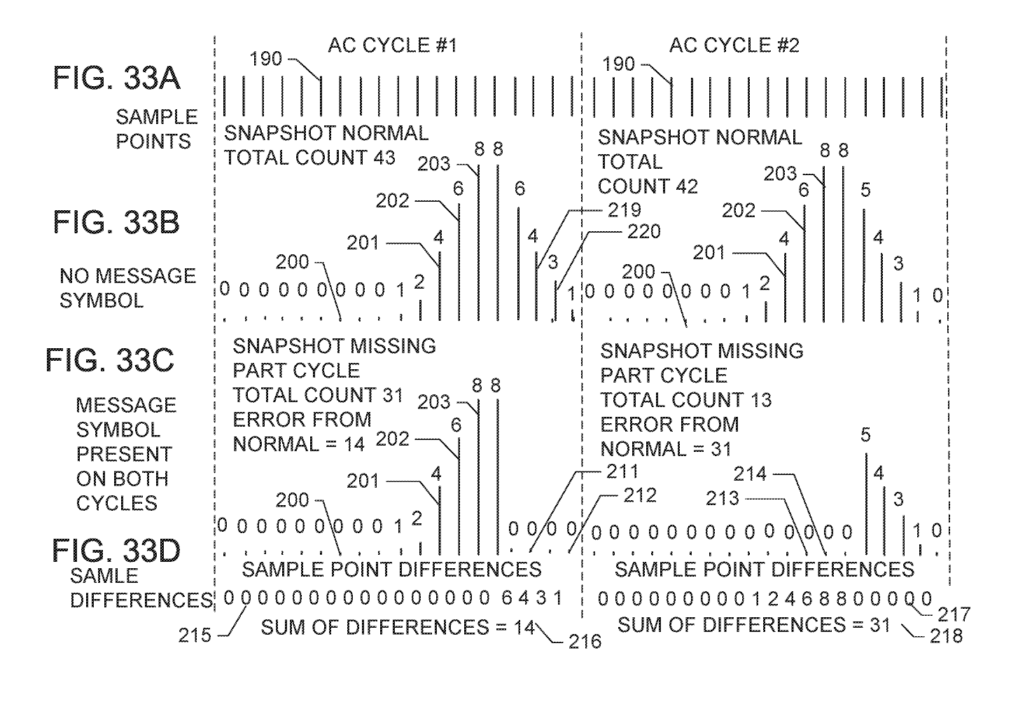

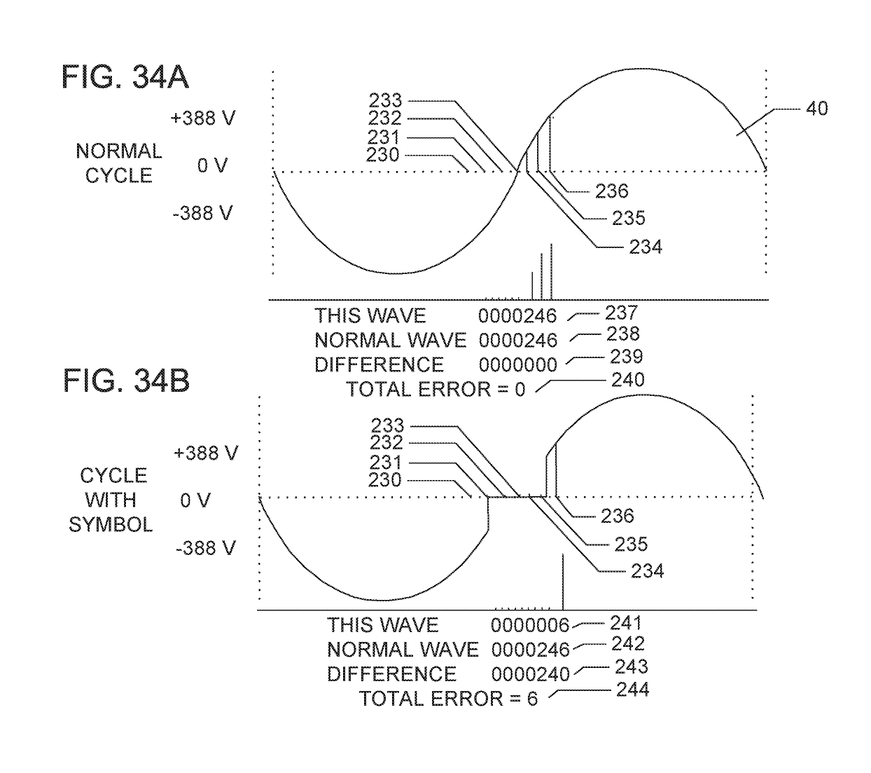

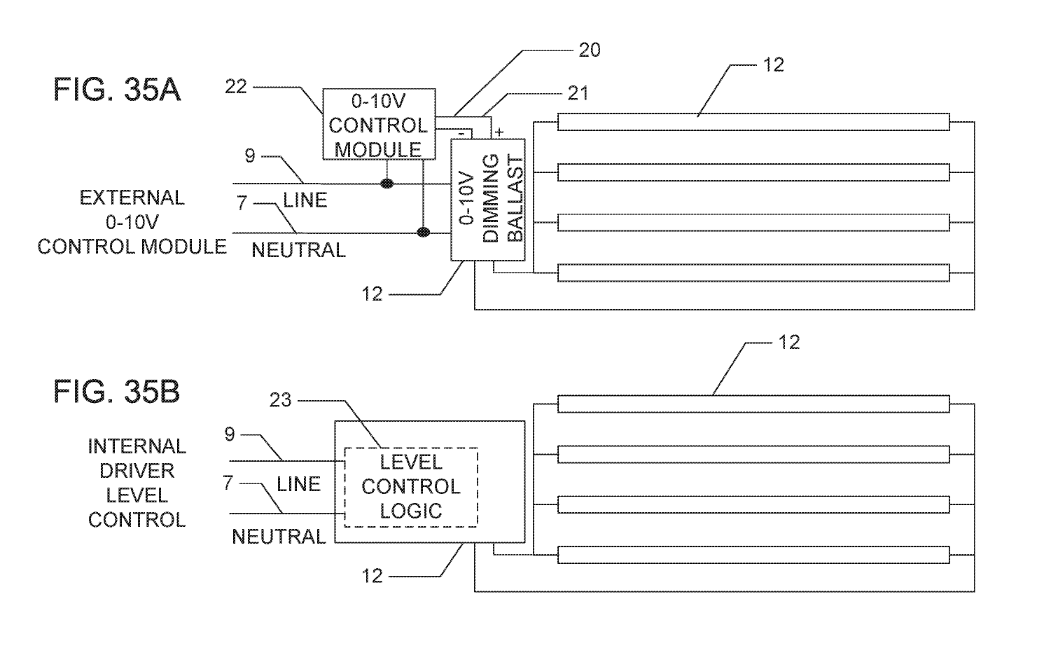

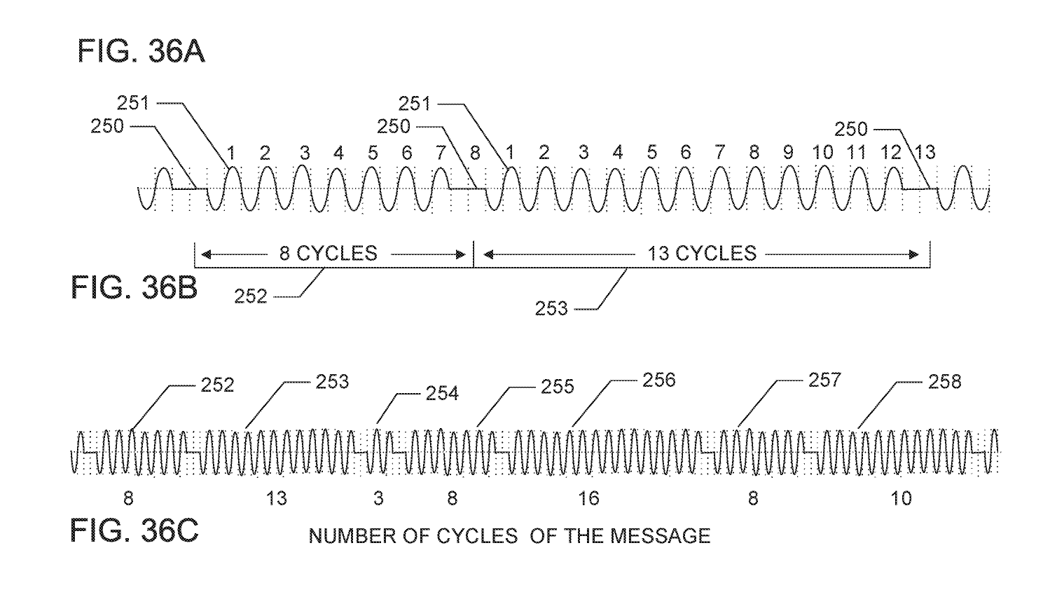

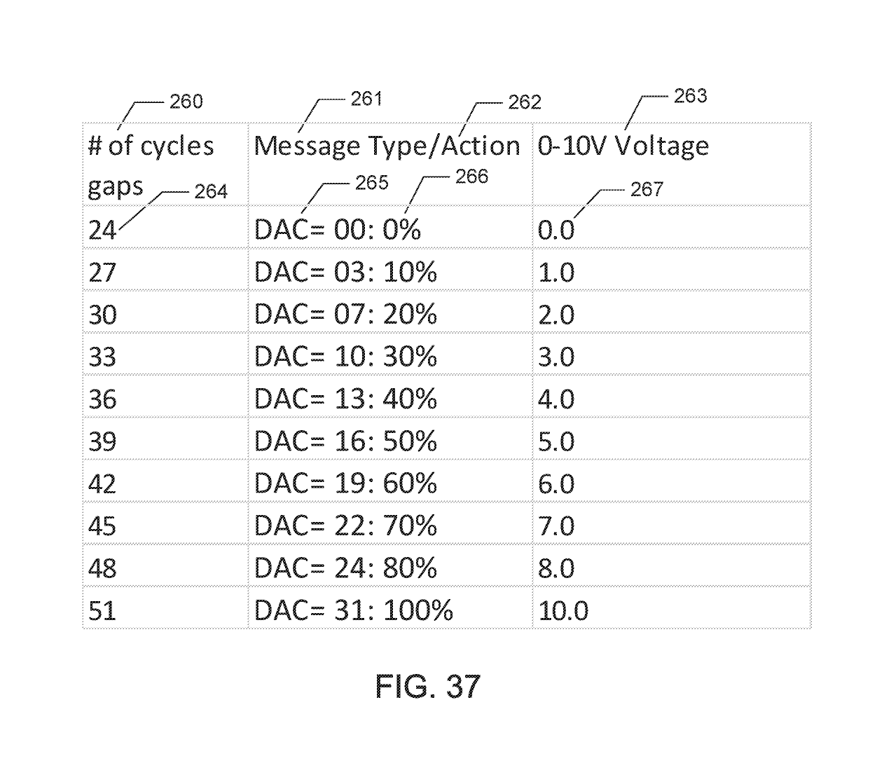

And, two, as shown in FIG. 6B, because the OFF function is supplied by the power relay in the timer, then NO ADDITIONAL PRIMARY POWER CONTROL RELAY IS NECESSARY IN THE RECEIVING MODULES. The only output required is the two 0-10 VDC connections, 20, 21.

The 0-10 VDC outputs are shown connected to the 0-10V circuitry 22D. As shown in FIG. 6A other control modules 22B used in wireless, hard-wired, or powerline communication systems MUST HAVE PRIMARY POWER RELAYS 19 or other switching devices in the receiving modules that are capable of turning the power ON and OFF to the lighting fixture. These conventional receiver modules must also have high-power, high-current connections 8, 9 to deliver ON and OFF power to the primary input of the lighting fixture. The small receiving modules that are part of the current system 22, do not need to supply the primary ON and OFF functionality since that functionality is still provided by the power relays installed in the timer.

FIG. 7 LIGHTING FIXTURE WIRING WITH CONTACTOR AND 0-10V CONTROL MODULES INSTALLED. This figure shows the wiring diagram of any typical wall box timer including a timer that would be used as the timer incorporating the new functionality of the current application. This figure also shows the circuit breaker panel supplying power to the time and two typical lighting fixtures controlled by the timer. Also shown is a power contactor installed after the timer that controls the power delivered to the lighting fixtures. Inside the lighting fixtures are shown the ballasts or drivers that power the light bulbs or LEDs and the special receiving modules that provided the multi-level control to the ballast/driver 0-10V input wires.

FIG. 8 TIMER BLOCK DIAGRAM. This figure shows the block diagram of the internal parts of a typical timer. The relay is clearly shown because the relay is the part of the timer that is used to produce the level-setting messages in the current application

FIG. 9 POSITIVE RISING MODULATION This figure shows one possible pattern that could be produced on the power line from the timer to the fixture by the timer power relay to produce level setting in the fixtures.

FIG. 10 POSITIVE FALLING MODULATION This figure shows one possible pattern that could be produced on the power line from the timer to the fixture by the timer power relay to produce level setting in the fixtures.

FIG. 11 NEGATIVE FALLING MODULATION. This figure shows one possible pattern that could be produced on the power line from the timer to the fixture by the timer power relay to produce level setting in the fixtures.

FIG. 12 NEGATIVE FALLING WITH DIGITAL SIGNALS. This figure shows one possible pattern that could be produced on the power line from the timer to the fixture by the timer power relay to produce level setting in the fixtures.

FIG. 13 NEGATIVE FALLING POSSIBLE MESSAGES. This figure shows one possible pattern that could be produced on the power line from the timer to the fixture by the timer power relay to produce level setting in the fixtures.

FIG. 14 NEGATIVE RISING POSSIBLE MESSAGES This figure shows one possible pattern that could be produced on the power line from the timer to the fixture by the timer power relay to produce level setting in the fixtures.

FIG. 15 MISSING NEGATIVE HALF CYCLE POSSIBLE MESSAGE This figure shows one possible pattern that could be produced on the power line from the timer to the fixture by the timer power relay to produce level setting in the fixtures.

FIG. 16 GAP POSITION METHOD MESSAGE This figure shows one possible pattern that could be produced on the power line from the timer to the fixture by the timer power relay to produce level setting in the fixtures.

FIG. 17 GAP WIDTH METHOD MESSAGE This figure shows one possible pattern that could be produced on the power line from the timer to the fixture by the timer power relay to produce level setting in the fixtures.

FIG. 18 RECEIVING MODULE POWER SUPPLY This figure shows the schematic components of the power supply of the receiving module.

FIG. 19 RECEIVING MODULEMICROPROCESSOR AND OP

FIG. 20 RECEIVING MODULE WITH A/D VOLTAGE INPUT This figure shows the schematic components of the receiving module less the power supply shown in FIG. 16.

FIG. 21 RECEIVING MODULE WITH Z/C VOLTAGE DIVIDER

FIG. 22 CONTACTOR TIMING MISSING ½ CYCLE This figure shows one possible pattern of removing ½ cycles that could be produced on the power line from the timer to the fixture by the timer power relay with control passed through a power contactor to produce level setting in the fixtures.

FIG. 23 CONTACTOR TIMING MISSING FULL CYCLE This figure shows one possible pattern of removing full cycles that could be produced on the power line from the timer to the fixture by the timer power relay with control passed through a power contactor to produce level setting in the fixtures.

FIG. 24 CONTACTOR RECEIVING PHASE B This figure shows how the contactor output would be received successfully by lighting fixtures that are on a different phase, Phase B, that the phase of the timer relay controlling the contactor.

FIG. 25 CONTACTOR RECEIVING PHASE C This figure shows how the contactor output would be received successfully by lighting fixtures that are on a different phase, Phase C, that the phase of the timer relay controlling the contactor.

FIG. 26 OCCPANCY SENSOR CONNECTED TO TIMER RELAY OUTPUT This figure shows how an occupancy sensor can be optionally connected to one of the timer output connections.

FIG. 27 ON/OFF TOGGLE SWITCH CONNECTED TO TIMER RELAY OUTPUT This figure shows how an over-ride toggle switch can be optionally connected to one of the timer output connections.

FIG. 28 DEMAND RESPONSE CONNECTED TO TIMER RELAY OUTPUT This figure shows how an occupancy sensor can be optionally connected to one of the timer output connections.

FIG. 29 VOLTAGE SAMPLE METHOD SAME PHASE This figure shows how a receiver microprocessor would take A/D voltage samples throughout a powerline cycle.

FIG. 30 VOLTAGE SAMPLE RECEIVING WHEN TRANSMITTER IS NOT SYNCHRONIZED TO ZERO CROSSING This figure shows how a receiver microprocessor would take A/D voltage samples throughout a powerline cycle for two cycles when the transmitting relay is on a different phase than that of the receiver or not synchronized to zero crossing.

FIG. 31 TRANSMITTING NOT SYNCHRONIZED This figure shows how a receiver microprocessor would take A/D voltage samples throughout a powerline cycle for three cycles when the transmitting relay is on a different phase than that of the receiver or not synchronized to zero crossing.

FIG. 32 VOLTAGE SAMPLES CALCULATIONS This figure shows how voltage levels from samples can be used to calculate a measure of if waveforms are normal or if a relay opening has produced a message symbol.

FIG. 33 SNAPSHOT CALCULATIONS This figure shows how voltage levels from samples taken over two different cycles can be used to calculate a measure of if waveforms are normal or if a relay opening has produced a message symbol appearing partially on the 1^{st} cycle and partially on the 2^{nd} cycle.

FIG. 34 MINIMUM DISTURBANCE VOLTAGE LEVEL METHOD This figure shows the basic difference between a lighting control receiving module that has primary voltage output control and a module that has no primary voltage output control.

FIG. 35 RECEIVING MODULES EXTERNAL AND INTERNAL This figure shows the lighting control receiving module embodiment where the module is a separate device installed in a fixture and an embodiment where the receiving module functionality is integrated inside of a LED driver.

FIG. 36 DATA MESSAGE This figure shows a typical data message with missing cycles forming the symbols.

FIG. 37 MESSAGE STRUCTURE This figure shows a basic message structure defined that includes 10 different lighting levels and the bright and dim functions. It also includes a multi-nibble method to write small amounts of configuration data into certain addresses with in the receiving module.

### DETAILED DESCRIPTION

In accordance with embodiments described and shown in the figures herein the primary, or most preferred purpose of the disclosed systems and methods is to enable the control of electrically powered lighting fixtures to establish any of several or multiple lighting levels when the fixtures are connected to a conventional timer or lighting control panel, except for relatively minor changes made to the firmware of the microprocessor that is incorporated into the conventional timer or lighting control panel, as described in detail herein. Additional, alternate embodiments enable and are adapted to control electrical power to the fixtures through intermediate lighting contactors and to allow for optional input connections by occupancy sensors or over-ride toggle switches, directly to timer power output terminals that can be configured to be used as inputs, or outputs.

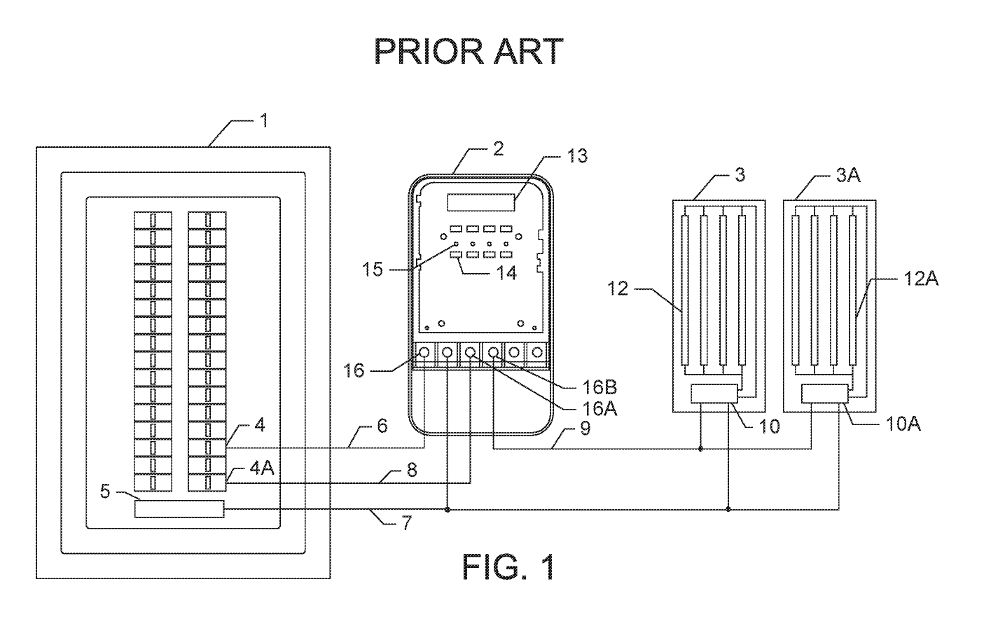

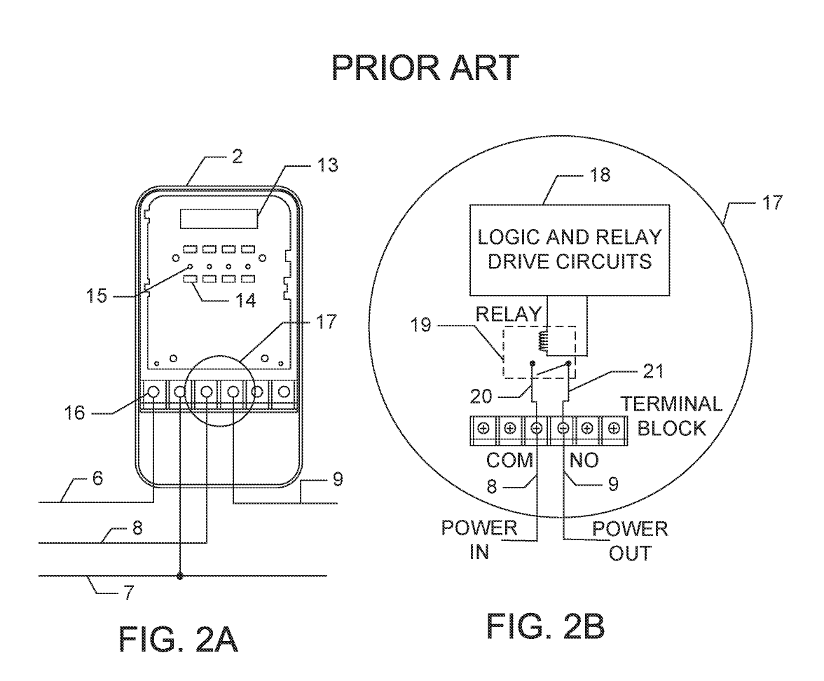

Conventional Timer Wiring FIGS. 1 and 2

A wiring diagram of a conventional wall-box timer 2 is shown in FIG. 1. This will be used as an example of an application. Also shown for clarity in FIG. 1 are circuit breaker panel 1, powering timer 2, and two lighting fixtures 3, 3A, each of which receives power from timer 2. Circuit breaker 4 powers timer 2 through circuit 6. Also, neutral bus 5, inside the circuit breaker panel 1, is connected to line 7 which connects to timer 2 and to fixtures 3, 3A.

Shown on the timer 2 are conventional features typically found on all conventional digital timers and lighting control panels, such as connector terminal block 16, display 13, buttons 14 and indicators 15.

A separate circuit 8, coming from a second circuit breaker 4A goes from the circuit breaker panel 1 into terminal in connector 16 and then out of the connector 16A to the load circuit wiring 9 to power the fixtures 3, 3A. Light bulbs, two of which are shown at 12, 12A and LED drivers 10, 10A are shown as positioned inside of light fixtures 3, 3A.

The above provided information describes and illustrates conventional electrical control devices and methods, and is believed to be well known to those skilled in this field.

Referring to prior art FIGS. 2A and 2B, a close-up view 17 of the logic 18 and relay 19 inside the timer is shown. Also shown are terminal block connections showing power going into the relay on lines 8 and 20 and power going out of the relay on lines 21 and 9. This information is also believed to be known to those skilled in this field.

Conventional relay 19 shown in FIG. 2B is shown with a conventional DC coil but a conventional relay for use in the present systems and methods could be a latching type of relay, with separate OPEN and CLOSE pulsing terminals. Either latching or non-latching relays can be used in the present systems and methods.

As will be described in detail below, only relatively minor changes are made to the conventional lighting control systems as show in FIGS. 1 and 2 in order to enable dramatically different and very advantageous uses of those systems to meet the multi-level lighting requirements of Title 24, and, in a more general sense, to enable improved and advantageous control of electrical loads other than lighting fixtures.

Several important and advantageous aspects of the currently disclosed systems, apparatuses and processes are that:
(a) The wiring of conventional timers can be identical to the wiring of the conventional timer in shown in FIG. 1.
(b) The preferred change to a conventional time to implement multi-level functionality in existing, typical, conventional lighting fixtures is incorporation of a relatively small receiving module inside of the typical, conventional fixture and connecting the module to the ballast/driver 0-10V input wires. No additional programming, addressing, or setup to the typical conventional fixture is necessary.

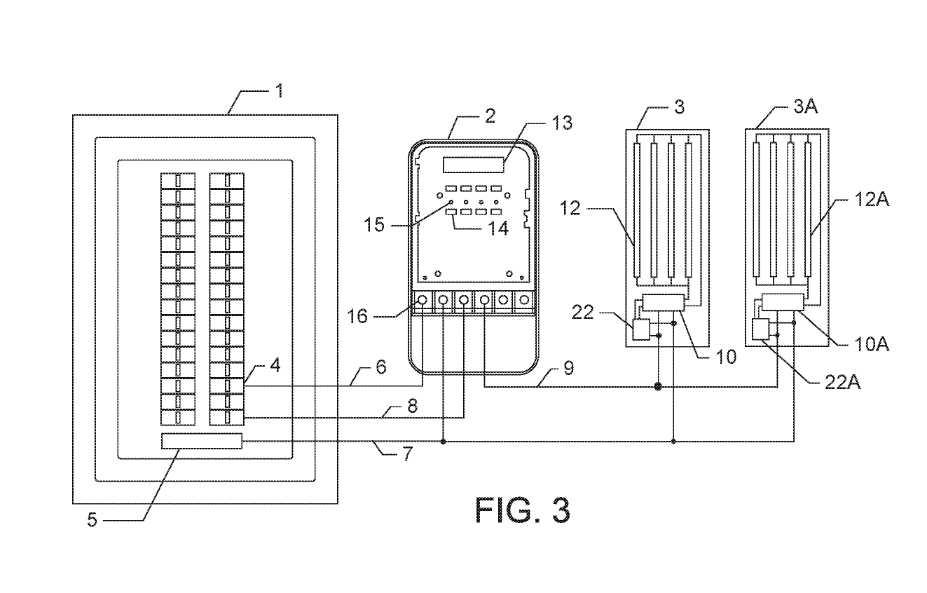

Preferred Embodiment Timer Wiring As Shown in FIGS. 3, 4, 5, 6, 7 and 8

FIG. 3 shows the same components as shown in FIG. 1, except that new receiving modules 22, 22A are installed inside the fixtures 3, 3A.

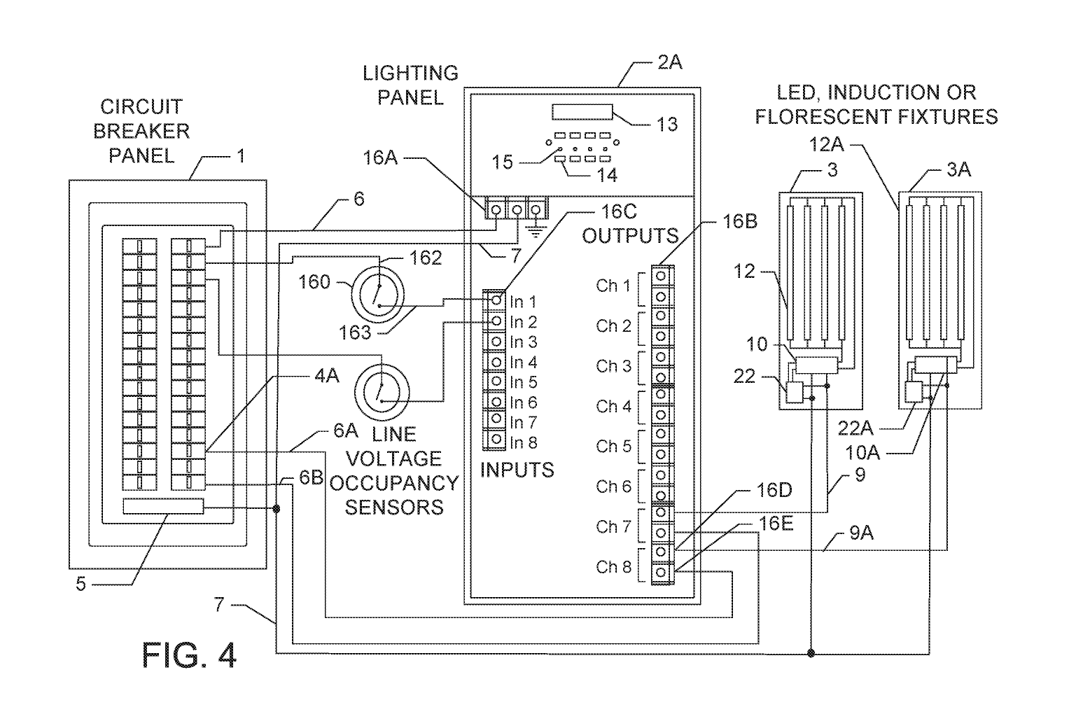

FIG. 4 shows the same components as shown in the FIG. 3 embodiment, except that a relatively larger, 8-channel lighting panel 2A is shown, instead of the smaller 2-channel timer 2 shown in FIGS. 1-3. Also, the FIG. 4 embodiment includes additional separate lighting panel power input connector 16A, separate load power output connector 16B and remote input sensor connector 16C. The channel 8 output connector 16B has one channel, #8, shown at 16E and has power coming in on line 6A from circuit breaker 4A in circuit breaker panel 1 and has power going out on line 9A at 16D to the lighting fixture 3A. A similar set of connections is shown in regard to the channel 7 output connector. Also shown at connector 16C, input line 1 is a connection to a conventional line voltage occupancy sensor 160, which is connected to line voltage from the circuit breaker panel on line 162 and is connected on line 163 to the lighting panel input line 1, shown at 16C.

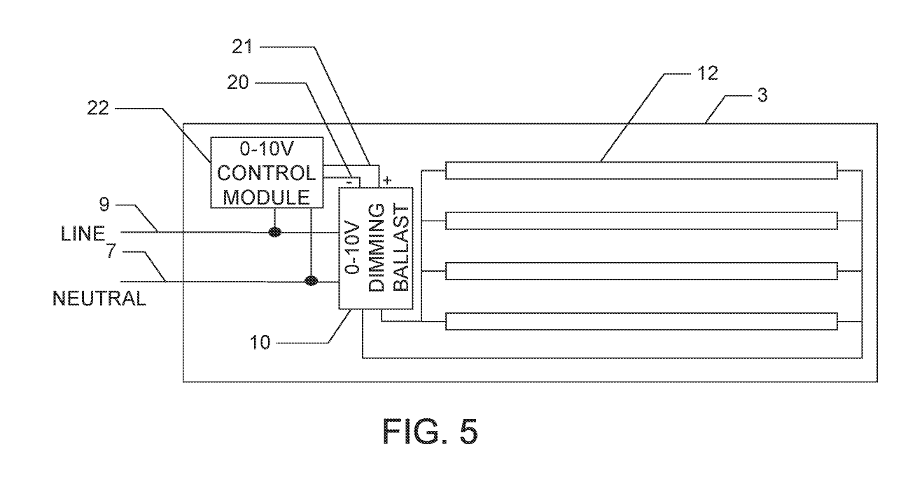

FIG. 5 shows details of the inside wiring of fixture 3. Power comes into and out of the fixture through line wire 9 and neutral wire 7, respectively, and connects to both the 0-10V dimming ballast 10 and 0-10V control module 22. Control module 22 is a novel and preferred aspect of the present systems and processes. There are two 0-10V wires 20, 21 coming out of the 0-10V control module 22 and going into the 0-10V dimming ballast/driver 10. According to standard convention the positive 0-10V wire (+) 21 is colored purple and the negative 0-10V wire (−) 20 is colored gray. The operation and construction of the preferred embodiment control module of the present system is described in detail later in this specification.

FIG. 6A shows a typical, conventional fixture control module 22B that would be installed inside a fixture and that functions to control the lighting level of the fixture. FIG. 6B shows a fixture control module 22 adapted to function in accordance with the principles of the presently disclosed systems and processes, and that would be installed inside a fixture to control the lighting level of the fixture. The main difference between the module 22B and module 22 is that conventional module 22B has a power control relay 19B that functions to turn the primary power On and Off to the fixture through the power control line 9. Separate high voltage power must enter and does enter into the module through line 8 and then leaves the module through line 9. Both modules 20 and 22B have receiving logic 22C and 0-10 VDC driver circuits 22D. However, only the conventional receiving module 22B has line power input, shown at 8 and line power output, shown at 9, and a power relay, shown at 19B. One typical, conventional fixture control module 22B that would be installed inside a fixture and that would include a primary ON and OFF control relay would be Powerline Control Systems GreenWorx® brand, model FCM1RD fixture control module. Another would be Lutron® brand model RMJ-5T-DV-B 0-10V Dimming Module.

One of the advantageous aspects of the present systems and processes is that no primary power control relay is needed in the fixture control module. Control modules used in conventional wireless, hard-wired, or powerline communication systems must have primary power relays or other switching devices in the receiving fixture control modules that are capable of turning the power to the lighting fixture ON and OFF.

The relatively small receiving modules that are part of the presently described system embodiments do not need to supply the primary ON and OFF functionality because that functionality is provided by the power relays installed in the timer. This aspect of the present systems allows the receiving control modules to be smaller, simpler and less expensive than the corresponding control modules in conventional lighting control systems. This aspect also provides a very significant cost advantages because the cost of a control module without a power relay and its connections is believed to be less than the cost of a conventional receiving module, and, in mass-production, a small fraction of the cost of a conventional receiving module.

The FIG. 7 embodiment has the same wiring diagram as shown in FIG. 3 except that a power contactor device 29 is installed between the timer 2 and the lighting loads 3, 3A. When using timers and lighting control panels to control multiple lighting loads, a contactor commonly uses as the primary ON/OFF control device to control multiple circuits at one time, or, in some instances, to control loads that are too large to be controlled by the relatively small relays inside of a timer of the type shown as timer 2. For example, a conventional contactor 29 can be selected to control 1000s of amperes and 6 or 12 circuits at one time. Contactor 29 shown in FIG. 7 controls two separate circuits 26, 27 from two separate inputs 24, 25 that are powered from circuit breakers on panel 1. As is known to those skilled in this field, the term “contactor” also refers to and means a large relay. Conventional small relays inside of timers and lighting control panels usually have small DC coils and contactors usually have large AC coils, one of which is shown at 28 in FIG. 7. The contactor 29 shown in FIG. 7 uses output power from the timer 2 on line 9 to control and power its AC coil 28. The contactor could be a latching type contactor or could be an electrically held contactor. The wiring from the timer 2 could be configured differently, and any such configuration would be considered to be equivalent, so long as the purpose of the present disclosure is carried out. The timer relay 19 or relays 19 would control the contactor 29 in order to produce the correct “click” on the contactor output power control lines 26, 27.

Referring to prior art FIG. 8, a block diagram of a conventional wall-box timer 2 is shown to assist in understanding the presently described systems and processes. Also shown in FIG. 8 are the basic conventional internal parts of a conventional wall-box timer. Typically a circuit represented with a single resistor 35, functions to monitor the AC waveform zero crossings on the main power supply input. A second zero-crossing monitoring resistor 36 is connected to microprocessor 33 at 32. Preferably, microprocessor 33 is a PIC12F1571 chip made by Microchip. Other conventional microprocessors may be used, so long as it functions to accomplish the objections of the present system. Monitoring resistor 36 is also connected to the AC powerline on relay input power line 8. Monitoring the AC power into relay 19 is necessary in order for the processor in the timer to be able to open and close the relay 19 near to the time of zero-crossing in order to minimize the damage to the relay contacts by the inrush current. This feature and structure is used on many conventional timers and lighting control panels.

In the presently disclosed systems the second zero-crossing monitoring resistor 36 is used for a second, innovative purpose. It is used to enable the timer processor 33 to monitor the zero crossing times on the circuit to which relay 19 is connected, so that the microprocessor 33 can produce correct predetermined patterns, as shown in and described with respect to other figures, to cause changes in the lighting levels in the fixtures. Second pull-down resistor 37 functions to enable the microprocessor to tell if the AC input power on line 8 is not connected to line voltage. If the signal at the microprocessor input 32 is always low it means that the input 8 is disconnected.

More than one relay 19 may be in or associated with a timer that is adapted for the present systems. A timer may have two, four or more relays, such as relay 19, and each such relay 19 could be connected to any one of the three phases in a three phase commercial installation. In accordance with the principles of the present system, each relay in circuit 8 and that is used in one of the present systems must have a zero crossing detection circuit, such as shown at 36, or the equivalent, so that microprocessor 33 can know the line zero crossing timings and so that the proper predetermined message(s) can be sent out, using the power relay 19, to fixture control modules 22 that are on that relay output circuit 9, which is also referred to as the load output line. One important aspect of this requirement is that most conventional, high quality timers and lighting control panels have zero crossing detection capability on each load circuit already in place. Thus, one important aspect of the present systems and processes is use of zero crossing information for production of the innovative messages used to control the lighting level modules 22 and thus to control the lighting levels in the fixtures that are in the controlled circuit. This use of zero crossing information is in addition to use of the information to maximize the life of the relay contacts.

Also shown in FIG. 8 are other typical parts of a conventional timer, such as communications bus 34 to which LCD display 34A, expander interface IC 34B, memory 34C, real time clock 34D, LED indicators 34E and push button switches 34F are shown. Also shown is transistor 39 and resistor 38 that are used by the microprocessor 33 to control the relay 19. Also shown are VDD 30 and ground 31 which are the power supply for the digital logic and microprocessor, all of which is conventional and believed to be known by those skilled in the electrical control panel and timer field.

The relay 19 shown in FIG. 8 is shown with a DC coil but a latching type of relay with separate OPEN and CLOSE pulsing terminals can be used in the present systems and processes. Either latching or non-latching relays can be used in these inventions.

Alternate Embodiments Timing Diagrams—FIGS. 9, 10, 11, 12, 13, 14, 15, 16, 17

FIG. 9 shows one preferred method of sending messages from timer 2 to receiving modules 22. By operating the relay 19, that is, opening and closing the relay at predetermined times, such as shown at 43, 44 and 45 relative the AC waveform 40 zero crossing times 41 and 42, messages can be sent downstream to the receiving modules 22 in the fixtures 3. Because conventional receiving modules can easily detect the three different delays in closing the relays, as shown at 43, 44 and 45 in FIG. 9A. Also, for example, considering three different delays in closing the relays, one at point 43 in FIG. 9A, point 44 in FIG. 9B, and point 45 in FIG. 9C, point 45, then the receiving module 22 can set the fixture to three different levels of lighting, such as a high or 100% level of lighting with a “high” message defined to be the message associated with the delay shown in FIG. 9A; a medium or 50% lighting level of lighting with a “medium” level message defined to be the message associated with the delay shown in FIG. 9B; and a low or 25% lighting level of lighting defined to be the message associated with the delay shown in FIG. 9C. As is shown and will be appreciated by those skilled in this field, this is a method of communicating and level setting using AC powerline width modulation because different messages are encoded according to the width of the aberration created on the powerline 40 by the power relay 19. This aberration is, by definition, the time between the time of zero crossing and the time the relay closes, or, as expressed alternatively, the time delay between the zero crossing time and the time when voltage is again applied to the circuit upon closing the relay in a particular phase of a particular controlled AC circuit. Such time delays are typically in the order of several microseconds on a conventional residential or commercial powerline.

It will be appreciated by those skilled in this field that the power relay 19 and the presently described system embodiment can be used in many, many different ways to send predetermined messages downstream to the level setting modules 22. Several different process embodiments, including preferred embodiments will be described with reference to the following figures. It will also be appreciated that many more combinations and permutations of these exemplary methods could be created and used in accordance with the principles described and exemplified herein. One of the principles is not in the narrow or limited, specific modulation method used, but rather is broadly that some form of predetermined pattern of messaging can be generated by operation of the power relay 19. This broad principle of messaging corresponds to and can be sent to control lighting levels in lighting fixtures in residential and/or commercial lighting control systems. More broadly, these principles can be used to create and send control messages to electrical loads other than lighting systems, such as fans, heaters and motors, to control operation of those loads, such as controlling fan speed and air flow, heat generation and motor speed, respectively,

FIG. 10 shows an alternate embodiment method of generating and sending messages from timer 2 to receiving modules 22. By operating the relay, and opening and closing at predetermined times shown in FIG. 10A at point 46, in FIG. 10B at point 47 and in FIG. 10C at point 48 relative the AC waveform zero crossing time shown at 42A, messages can be sent downstream to the receiving modules in the fixtures 22. Because conventional receiving modules can easily detect the three different time delays represented at points 46, 47 and 48, the receiving module can set the lighting fixture to any of three different light levels, or in the case of a non-lighting load, set the operation of the load to any of three different operating points or conditions. Thus, FIG. 10 illustrates an alternate embodiment of powerline time delay or width modulation-based messaging or communication. Different messages are encoded by and correspond to the width of the aberration, or time delay between the zero crossing time and the time when voltage appears on the line for a given cycle or part of a cycle in an alternating current electrical system, which time delay is created on the powerline to the controlled load by the power relay 19. The only difference between the FIG. 9 and FIG. 10 embodiments is that the FIG. 9 embodiment has the powerline aberrations or delay positioned in the increasing positive part of the cycle near the positive zero crossing (as the voltage increases positive) and the FIG. 10 embodiment has the powerline aberrations or delay positioned in the decreasing positive part of the cycle near negative zero crossing (as the positive voltage decreases toward the zero crossing point in that specific cycle). Both methods work for their intended purpose.

FIG. 11 shows an alternate width modulation embodiment method of sending messages from the timer 2 to the receiving modules 22. By operating the relay to open and close the relay at predetermined times such as shown in FIG. 11A at point 51; in FIG. 11B at point 52 and in FIG. 11C at point 53, relative the AC waveform zero crossing time 42, related messages can be sent downstream to the receiving modules in the fixtures 22. Because the receiving module can easily detect the three different delays 51, 52 and 53 shown in FIG. 11 then the receiving module can set the fixture to three different lighting levels. This is an alternate embodiment width modulation method of communicating and level setting because different messages are encoded by the width of the aberration created on the powerline by the power relay 19, and as described above. The difference between FIG. 10 and FIG. 11 is that FIG. 10 has the powerline aberrations on the decreasing positive part of the cycle, just before the negative zero crossing and the FIG. 11 embodiment has the aberrations on the decreasing negative part of the cycle, just after the negative zero crossing. Both methods will work but the method shown in FIG. 11 is the most or one of the most preferred embodiments.

FIG. 12 shows more detail of the method shown in FIG. 9 embodiment of sending messages from the timer 2 to the receiving modules 22, and includes description of clipping, or digitizing the AC voltage so that it can be an input to the microprocessor. By operating the relay 19 to open and close it, and opening the relay at 42 and closing the relay at points 51, 52, 53 at predetermined times relative the AC waveform zero crossing time 41, messages can be sent downstream to the receiving modules in the fixtures 22. Because the receiving module can easily detect the three different delays 51, 52, 53 shown here, then the receiving module can set the fixture to three different light levels.

FIG. 12A shows a normal AC waveform 40 that would appear on the line out 9 of the relay 19 to the lighting fixtures 3, 3A. This would be the normal AC waveform when the relay is closed, the fixture is powered ON and the zero crossing times are shown at 41, 42. FIG. 12B shows the digital zero-crossing signal that would be observed on the small receiving modules 22 installed in the fixtures. The digital waveform is a clipped form of the actual waveform 40, but clipped to +5 VDC and 0 VDC so that the signal can be input safely into the microprocessor. This “clipping” of an AC signal so it can be read in the input of a microprocessor is well known to those skilled in this field. The square wave signal shown in FIG. 12B is used by the microprocessor in the receiver module 22 to detect when the zero-crossings have occurred. It can be seen that the rising edge 60 on FIG. 12B is at the same point as the rising zero crossing 41 on FIG. 12A. The falling edge 61 of the FIG. 12B digital wave form in FIG. 12B is at the same point as the falling zero crossing 42 as shown in FIG. 12A, and the time between the two zero crossings is shown as X1.

FIG. 12C shows an AC waveform 40 that would appear on the line out 9 of the relay 19 to the lighting fixtures 3, 3A. This would be the normal AC waveform when the relay is closed and the fixture is powered ON but with one predetermined aberration inserted into the waveform at 53. In this embodiment the relay 19 has been opened briefly and then closed in order to remove power from the power line 9 to the relay to the fixtures from the time of opening the relay at point 42 and then closing the relay, as shown at point 53. FIG. 12D shows the corresponding digital zero-crossing signals that would be observed on the small receiving modules 22 installed in the fixtures 3, 3A. As also shown in reference to FIG. 12B, the digital waveform is a clipped form of the actual waveform 40, but is clipped by at +5 VDC and 0VDC so that the signals can be input safely into the microprocessor. This “clipping” of an AC signal so it can be read in the input of a microprocessor is well known to those skilled in this field. The FIGS. 12B and 12D square waves are used by the microprocessor to detect where the zero-crossings have occurred. It can be seen that the rising edges 60 of FIG. 12B and of FIG. 12D are at the same point as the rising zero crossing 41, but that the falling edge at 61 of FIG. 12B and the falling edge at 62 of the left side cycle shown in FIG. 12D are at different points, that is, at different times after the zero crossing. Thus, as shown in the left side half cycles of FIGS. 12B and 12D, the time-distance between 60 and 61, shown as X1 in FIG. 12B is different, and is less/shorter than the time-distance between 60 and 62, shown as X2 in FIG. 12D.

The falling edge 61 of 12B is at the same point as the falling zero crossing 42 but the falling edge of the 12D signal at the aberration 53 has been delayed until point 62. The microprocessor can easily detect that the time X2 between the rising and falling zero crossings 60, 62, is much greater than the normal 60 HZ zero crossing period X1 of 8.3 msec, that is, the time from point 60 to point 61. In the preferred embodiment the time X2 would be about 1-2 msec longer than the normal time of 8.3 msec. This greater or longer time is very easily and reliably detected by the microprocessor.

Referring again to FIG. 12, it can be seen that it is possible to open the relay at point 42 and then close the relay at 53 as shown in FIG. 12C, but it would also be possible to close the relay at points 51 or 52, and then the time X2 would be shorter. The three different times could be interpreted by the microprocessor as three different messages, such as HIGH, MEDIUM and LOW lighting levels. For the purpose of the present disclosure, the term “width modulation” is used to refer to the message information that is encoded in the width of the signal X2. While the FIG. 12 embodiment will work for its intended purpose, the embodiment of FIG. 11 is preferred. The FIG. 12 embodiment has been found to be susceptible to noise and normal powerline aberrations caused by the utility company or other loads, while the FIG. 11 embodiment has not shown such susceptibility.

FIG. 13 shows an alternate embodiment method of encoding messages using the basic method of operating the relay as shown in FIG. 9, but with one significant difference. In the FIG. 13 embodiment the “modulation” is not encoded within the width of the powerline aberration but in the positions on the powerline 70, shown at 71, at which each of the multiple, sequential aberrations are located in a predetermined series of AC cycles. Each aberration 71 is the same as the other aberrations 71, but the pattern of the aberrations in relation to the number cycles between the aberrations determines the content of message. In the FIG. 13 embodiment, there are examples of how three different messages could be arranged. In each of FIGS. 13A, 13B and 13C there are eight powerline cycles 70 used to form the messages. The relay 19 is controlled by the microprocessor 33 to place the aberrations 71 at specific cycles in order to make a specific, predetermined pattern. It is very easy for a receiving module to detect these different patterns.

In this example the aberrations 71 are represented by binary “1”s symbols, and the absence of an aberration, or symbol is represented by a binary “0”. In this example, where eight powerline cycles are used as the base number of cycles within which the messages are encoded, the eight cycles are shown with a pattern or series of binary “1”s and “0”s of 10010000. In this example, this pattern is defined to represent or mean or is interpreted to mean a GOTO HIGH command. Similarly, the series of 10000100 is set to represent a GOTO MEDIUM command, and the series of 10000001 is set to represent a GOTO LOW command. It will be appreciated that the number of cycles between two symbols can represent different messages, commands or lighting levels.

On advantageous aspect of the FIG. 13 embodiment method of modulation is that this method does not depend upon accurate detection of specific widths of each aberration as, is important in the width modulation method shown in FIGS. 9, 10, 11 and 12. In the position modulation embodiment method, as shown in FIG. 13, the receiving module need only detect which cycles contain an aberration or symbol and which cycles do not. If there is powerline noise that would corrupt the width of any aberration(s), such noise would not matter and would not degrade the position modulation method of controlling the lighting level of the fixtures, or controlling the operation of a non-lighting load. The width of any symbol or aberration transmitted along the powerline can be large or small, so as long as it can be distinguished from a cycle having no such symbol or aberration. The position modulation process is less susceptible to corruption by powerline noise than is the width modulation process as shown and described in relation to FIGS. 9, 10, 11 and 12.

Numerous specific sequences of aberrations or symbols may be used in accordance with the broad position modulation process described herein. As so broadly envisioned, the position modulation process preferably uses the primary power control relay to both control the primary power to the lighting fixtures on the circuit or to other electrical loads on the system, and to produce predetermined symbols, or aberrations in the powerline cycles and which aberrations or symbols function as control messages used to control light levels in lighting fixtures or to control operating parameters in other electrical loads on the circuit, such as fan, heater and motor loads on a similarly controlled circuit.

The embodiment shown in FIG. 14 is like the FIG. 13 embodiment, except that the aberrations are produced on the rising negative voltage part of the powerline, just before the zero-crossing instead of the decreasing negative voltage part of the powerline, just after the negative zero-crossing. The FIG. 14 embodiment is presented to show that there are many combinations of symbols, or aberrations that are in accordance with the principles herein and that could be used to transmit messages on AC circuits controlled by relays. Thus, one important aspect of the disclosed systems and processes is the use of the primary power control relay to be used to both control the primary power to the lighting fixtures on the circuit, or to control other non-lighting loads, and to produce predetermined aberrations in the powerline cycles that effectively send level setting messages to the lighting fixtures on the circuit, or send control messages to the other, non-lighting loads, which messages are not limited to any specific pattern of aberration in the powerline. As such, there are virtually an unlimited number of possible patterns that would work effectively within the principles of the present disclosure.

FIG. 15 shows yet another scheme or embodiment of modulation where the aberration in the powerline is produced in a normal powerline waveform 70 by the relay opening so that an entire negative ½ cycle of the powerline is missing at predetermined times, as shown at 76, 76 in FIG. 15A. FIG. 15B shows corresponding digital zero-crossing signals that would be observed on the small receiving modules 22 installed in the fixtures. The FIG. 15B waveform is a clipped form of the actual waveform of FIG. 15A, but is clipped by at +5 VDC and 0 VDC so that the signal can be input safely into the microprocessor. This “clipping” of an AC signal so it can be read in the input of, and then used by a microprocessor is well known to those skilled in this field. This FIG. 15B square wave is used by the microprocessor to detect the location of the missing negative ½ cycles, shown at 78, 78. Also shown in FIGS. 15B, 15D and 15F are the digital representations of exemplary messages, shown as 010010000, 0100001000, and 010000010 respectively. These messages could, for example, represent possible HIGH, MEDIUM and LOW light level commands for a lighting fixture, or some other command to a non-lighting load on a circuit that uses this type of process and coding. The digital waveforms shown in FIGS. 15B, 15D and 15F would appear on the input pin of a receiving microprocessor and are derived from the AC waveforms 15A, 15C, and 15E respectively, as will be appreciated by those skilled in this field.

The FIG. 15 embodiment is a particular process of producing the aberrations that would be very reliable and robust because the aberration is so large. Skipping an entire ½ cycle (8.33 msec), as shown in FIGS. 15A, 15C, and 15E would be much more impervious to corruption by powerline noise than skipping only 1 or 2 msec of a ½ cycle as shown in comparison to the examples of FIGS. 9, 10, 11, 12, 13 and 14.

FIG. 16 shows yet another example or embodiment process of modulation. In the FIG. 16 process, the aberration is produced in a normal powerline waveform 70, shown in FIG. 13A, by the relay opening after the zero crossing so that a small part of the cycle missing, shown at 84. FIGS. 16B and 16C shows how the small aberration or gap in the waveform that forms the aberration can be placed in different position, such as shown at 85 and 86, in order to produce different messages. For example, there could be predetermined positions 81, 82 and 83 where the aberration can be located by the receiving module. The receiving module would be programmed to detect the aberration and then decide which message, and corresponding light level command (or other type of commend for a non-light load on such a circuit) was sent, based on the position of the gap 84, 85 or 86 along the waveform relative to the AC zero-crossing 80.

FIG. 17 shows yet another example or embodiment process of modulation. In the FIG. 17 process, the aberration is produced in a normal powerline waveform 70, as shown in FIG. 17A by the relay opening so that a small part of the cycle missing at 87. FIGS. 17B and 17C show how the small gap type aberration can be of different widths 87, 88 and 89 in order to produce different messages. For example, one predetermined position 81 could be the designated starting point of the message, but gaps of different widths would provide the substance or actual content of the message. The receiving module would be programmed to detect the initial presence and width of the aberration or gap, and then determine the content of the message, such as which level command was sent based on the width of the gap 87, 88 or and 89 as shown in FIGS. 17A, 17B and 17C.

Alternatively, the presently disclosed process could be used to achieve the same result as that of the FIG. 17 embodiment, by turning the power OFF and ON at large time intervals and creating relatively large gaps, such as several seconds or minutes in time or length. These power ON/OFF possibilities are considered to be within the principles described herein, but are believed to be inferior because of the visible effect of tuning the lighting fixtures ON and OFF in such patterns may adversely affect the users or other persons who are working or otherwise at the places illuminated by the thus controlled lighting fixtures.

It is also envisioned that control messages could be created and transmitted by turning the relay OFF and ON, and using or establishing a timing relationship between such action(s) and the international time clock or some other time reference. However, such a process would require additional complexity to be incorporated into the receiving module, even though such a process would still use the primary power control relay to send information downstream to the lighting fixtures, or other non-lighting load and are considered to be in accordance with the principles of the present disclosure.

FIGS. 18 and 19 are schematic diagrams of the preferred receiving module 22 installed in the fixtures 3, 3A and enable the timer 2 to send commands using the relays 19 to change the light levels in the fixtures 3, 3A.

FIG. 18 shows a simple power supply. The power supply is connected to the AC powerline 90 and AC neutral line 91 inside the each fixture 3, 3A. The line 90 goes through a capacitor 92 that reduces the voltage to a low level. Then the current is rectified by diodes 95 and 93. An inductor 94 is inserted in series with the rectifying diode 95 to reduce high frequency noise to the power supply. A Zener diode 102 keeps the rectified voltage to a nominal 10 VDC, at 101. Large electrolytic capacitors 96, 98 store the charge at 10 VDC at 101.

A conventional linear voltage regulator 97 reduces the 10V at 101 to 3.3 VDC at 99, as is required by the microprocessor 106, shown on FIG. 19.

FIG. 19 shows the microprocessor 106 and op amp 109 circuits. The AC line in is connected to the processor through resistor 114, and forms the zero crossing detection circuit. This is also the input to and that allows the processor 106 to detect the different powerline patterns produced by the timer 2 relay 19 to send in messages for the microprocessor to change the 0-10 VDC lighting levels 112. Resistor 103 is a pull up resistor to keep the zero crossing input high when the relay is open and there is no line voltage present through resistor 114.

The op amp circuit has a conventional non-inverting configuration that is believed to be familiar to those skilled in this field. On the processor 106 pin 7 RA0 has a D/A digital to analog driver built into the PIC12F1571 processor 106. Because the power supply to the processor 99 is limited to 3.3 VDC the op amp is used to multiply the voltage at pin 7 times three so that the output to the fixture 112 can cover or span the range of 0-10 VDC. This is done by setting the feedback resistors in the non-inverting op amp configuration to a gain of 3. The amplification with the op amp circuit has a conventional non-inverting configuration with gain that will be understood to those skilled in this field. Resistor 111 and capacitor 113 on the output of the op amp form a filter to achieve and/or improve stable operation of the high gain LM 358 op amp 109.

FIG. 20 is a schematic diagram, as similar to FIG. 19, but with the addition of resistors 115 and 116 that function as a voltage divider and to provide a voltage proportional to the powerline voltage into pin 6 of the microprocessor which is an A/D input that can measure the analog voltage of the input. In FIG. 19 the input from the powerline to the processor at pin 5 can only detect if the signal is high or low. In FIG. 20 the input on pin 6 can actually measure the voltage. This preferred, particular processor has a 10 bid A/D inside so the voltage can be measured to a resolution of about 1/1000.

The voltage dividing scheme used with the FIG. 20 circuit, that is, with resistors 103, 114, 115, and 116, is adapted to, and functions such that the final maximum voltage into the microprocessor will be slightly less than the 4 VDC that the microprocessor can measure. This adaptation takes into account the fact that the maximum peak powerline voltage for a 277 VAC powerline is 387 VDC, as is known to those skilled in this field.

This above referenced adaptation for the powerline voltage to be measured with an analog A/D to much more powerful error resistant symbol or powerline aberration detection will be explained with reference to other figures below.

FIG. 21 is a schematic diagram similar to the FIG. 19 diagram, but with the addition of resistors 118 adapted to be and functioning as a voltage divider and to providing input voltage to the microprocessor digital input pin that is about 10% of the full line voltage. This means that the actual line voltage would have to get up to about 20V before the input would turn into a digital “1” which is when the voltage on the microprocessor input pin is above 2 VDC. This also means the powerline voltage would have to be below 8V before the input pin would produce a valid digital “0”, which would occur when the pin voltage is below 0.8 VDC. Adding resistor 118 as a 10% voltage divider helps increase the noise immunity of the circuit of FIG. 19 by reducing false “1”s from being produced.

FIGS. 22A, 22B and 22C shows the relay 19 from FIG. 2 in a timer can be used to send the message through a secondary contactor 29 from FIG. 7 to the receiving module 22 located in the lighting fixture 3. FIG. 22A shows an AC waveform 127 that goes from the relay 19 to the contactor 29 coil 28. The relay is timed to open for the entire ½ cycle 122 producing a loss of drive voltage for the entire ½ cycle 122. Because there is a delay associated with the contactor opening, the contactor does not open until point 130, and then stays open until point 125. As shown in FIG. 19, there is a pull-up resistor 103 on the microprocessor input line 105 at pin 5. If the input at pin 5 is disconnected from the powerline when the relay is open, as shown in FIG. 22A at 122, then there will be a high signal 132 as shown in FIG. 22C. This in turn produces an additional section of 5V high signal 132 in FIG. 22C, that is, in addition to the normal 8.33 msec of high signal 131 that is very easy for the receiving module microprocessor to detect. This additional section of high signal 132 can be interpreted as a binary 1 where the normal section of high signal alone 131 would be a binary 0. Therefore FIG. 18 shows just one way a contactor 29 can pass a message from the relay 19 in the timer to the receiving module 22 in the fixture 3 as shown in FIG. 3.

FIGS. 23A, 23B, 23C and 23D show how the relay 19 from FIG. 2 can be used to send a message through a secondary contactor 29 from FIG. 7 to the receiving module 22 located in the lighting fixture 3. The difference between FIG. 22 and FIG. 23 is that in FIG. 22 the relay is only open for ½ cycle from point 121 to point 120, where in FIG. 23 the timer relay is open for a full cycle, shown at 133 and 134, each of which represents the time for a ½ cycle. This adaptation of opening the relay for a full cycle makes the system and process more reliable to transmit the signal through a contactor when the opening and closing delays are unknown.

FIG. 23A shows an AC waveform 127 that goes from the relay 19 to the contactor 29 coil 28. The relay is timed to open for the entire full cycle 133,134 producing a loss of drive voltage for the entire full cycle 133,134. As shown in FIG. 23B, there is a delay in the contactor outputs opening the contactor does not open until point 135,136.

As shown in FIG. 19, there is a pull-up resistor 103 on the microprocessor input line 105 at pin 5. If the input at pin 5 is disconnected from the powerline when the relay is open, as shown in FIG. 23B at 135, then there will be an abnormal high signal 137 as shown in FIG. 23C.

The result is an additional section of 5V high signal 137 in FIG. 23C, and that is in addition to the normal 8.33 msec of high signal 138 that is very easy for the receiving module microprocessor to detect. As shown in FIG. 23D this additional section of high signal 137 can be interpreted as a binary 1 where the normal section of low signal alone 139 would be a interpreted as a binary 0. Therefore FIG. 23 shows just another, alternate way a contactor 29 can pass a message from the relay 19 in the timer to the receiving module 22 in the fixture 3, as shown in FIG. 7. As shown in FIG. 23D a digital message is produced that is a binary 001001000 where the absence of a timer-sent message would have resulted in a binary 000000000 for the same set of nine cycles.

FIG. 24 shows how a symbol or signal from the relay in a timer can be passed through a contactor to receiving modules even though the AC power connected to the output of the contactor is on a different phase from the power coming from the timer relay to the coil of the contactor.

FIGS. 24A and 24B show the waveforms for a contactor output connected to Phase A and FIGS. 24C and 24D show the waveforms for a contactor output connected to Phase B where there is a 120 degree offset from Phase A.

FIG. 24A shows the AC waveform coming from a contactor if the contactor is wired to Phase A. The contactor output is open for AC ½ cycles 135 and 136. This is from phase A of the 3-phase power from a building. As shown in FIG. 19, assuming there is a pull-up resistor 103 on the microprocessor input line 105 at pin 5, there will be a high signal 137 as shown in FIG. 24B if a receiver is located directly on the contactor output circuit wired to Phase A. If the relay was not sending a “click”, or opening downstream then ½ cycle shown at 137 would have been low.

When the contactor is open as is shown in FIG. 24A between points 135 and 136 FIG. 24C shows how the signal would appear if one of the contactor outputs is wired to Phase B of the building AC power. The AC waveform is missing for 16.66 msec from point 146 to 147. Even though Phase B is shifted by 120 degrees, an abnormal “high” area, or aberration, or symbol is produced at 145 in FIG. 24D. This aberration or symbol is easily detected by the receiving module. The result of this situation is that a receiving module can detect a “symbol” or signal that is originally generated by a relay from the timer, after going through a contactor regardless of which phase the contactor output is wired to.

FIG. 25 shows how a symbol from the relay in a timer can be passed through a contactor to receiving modules even though the AC power connected to the output of the contactor is on a different phase from the power coming from the timer relay to the coil of the contactor.

FIG. 25A and 25B show the waveforms for a contactor output connected to Phase A and FIG. 25C and 25D show the waveforms for a contactor output connected to Phase C where there is a 120 degree offset from Phase A. The difference between FIG. 24 and FIG. 25 is that Phase B is shifted 120 degrees to the right and Phase C is shifted 120 degrees to the left.

FIG. 25A shows the AC waveform coming from a contactor if the contactor is wired to Phase A. The contactor output is open for AC ½ cycles 135 and 136. This is from phase A of the 3-phase power from a building. As shown in FIG. 19, assuming there is a pull-up resistor 103 on the microprocessor input line 105 at pin 5, there will be a high signal 137 as shown in FIG. 25B if a receiver is located directly on the contactor output circuit wired to Phase A. If the relay was not sending a “click”, or opening downstream then ½ cycle shown at 137 would have been low.

When the contactor is open as is shown in FIG. 25A between points 135 and 136 FIG. 25C shows how the signal would appear if one of the contactor outputs is wired to Phase B of the building AC power. The AC waveform is missing for 16.66 msec from point 156 to 157. Even though Phase C is shifted by 120 degrees, an abnormal “high” area, or aberration, or symbol is produced at 154 in FIG. 25D. This aberration or symbol is easily detected by the receiving module. The result of this situation is that a receiving module can detect a “symbol” that is originally generated by a relay from the timer, after going through a contactor and regardless of which phase the contactor output is wired to.

FIG. 26, shows how a connection that would normally be and function as a power relay output can also be used to function as an input. This adaptation is considered to be a significant innovation within the overall principles of the present disclosure. No other timer or lighting panel that can configure the output connections as either outputs or inputs is presently known. On a timer that has limited space for connections this innovative feature and capability is believed to be extremely advantageous and valuable.

FIG. 3 shows how the relay connection 8 that normally would be the power line input connection into the relay and that would go out of the relay 9 to control lighting fixtures 3. A conventional line voltage occupancy sensor 160 incorporates a small power control switch or relay 161 that feeds power from an input 162 to an output 163 when the occupancy sensor senses occupancy. This output 163 from the occupancy sensor is connected to the unused relay power input 8 on the timer. This channel of the timer, which is going to be used as an input from the occupancy sensor, is set to be an input in the timer configuration menu. After it is set to an input the channel zero crossing sense pin at 32 can now detect if the occupancy sensor is triggered or not. If the occupancy sensor is triggered, a normal line voltage zero crossing, high/low/high/low etc., will be detected at point 32. Resistor 36 protects the microprocessor input from high voltage and high current. Resistor 37 is a pull-down resistor that functions to keep the input low continuously, low/low/low/low, if the occupancy sensor switch 161 is open. Thus, it is easy for the microprocessor to detect if the occupancy sensor is triggered or not.

FIG. 27 shows how a connection that would normally be a power relay output can also be used as an input. This adaptation is also considered to be a significant innovation within the overall principles of the present disclosure. No other timer or lighting panel that can configure the output connections as either outputs or inputs is presently known. On a timer that has limited space for connections it is believed that this innovative feature is very advantageous and valuable.

FIG. 3 shows how the relay connection 8 that normally would be the power line input connection into the relay and that would go out of the relay 9 to control lighting fixtures 3. A conventional line voltage toggle switch 165 incorporates a small power control switch 166 that feeds power from an input 167 to an output 168 when the switch is turned on. This output from switch 165 is connected to the unused relay power input 8 line on the timer. This channel of the timer which is going to be used as an input from the occupancy sensor is set to be an input in the timer configuration menu. After it is set to be an input the channel zero crossing, sense pin at 32 can now detect if the switch is turned on or off. If the switch is on a normal line voltage zero crossing, high/low/high/low etc., will be detected at point 32. Resistor 36 protects the microprocessor input from high voltage and high current. Resistor 37 is a pull-down resistor to keep the input low continuously, low/low/low/low if the switch 165 is off or open. It is easy for the microprocessor to detect if the switch 165 is on or off.

FIG. 28, shows how a connection that would normally be a power relay output can also be used as an input. This is adaptation is also considered to be a significant innovation and within the principles of the present disclosure. No other timer or lighting panel that can configure the output connections as either outputs or inputs is presently known. On a timer that has limited space for connections, it is believed that this innovative feature can be very advantageous and valuable.

FIG. 3 shows how the relay connection 8 that normally would be the power line input connection into the relay that would go out of the relay 9 to control lighting fixtures 3. A conventional line voltage demand response relay 171 incorporates a small power control switch or relay 173 that feeds power from an input 174 to an output 172 when the demand response relay is triggered. This output 172 from the demand response relay is connected to the unused relay power input 8 line on the timer. The channel of the timer which is going to be used as an input from the demand response relay is set to be an input in the timer configuration menu. After it is set to an input the channel, zero crossing sense pin at 32 can now detect if the demand response relay is triggered or not. If the demand response relay is triggered, then a normal line voltage zero crossing, high/low/high/low etc., will be detected at point 32. Resistor 36 protects the microprocessor input from high voltage and high current. Resistor 37 is a pull-down resistor to keep the input low continuously, low/low/low/low, if the demand response relay switch 173 is open. It is easy for the microprocessor to detect if the demand response relay is open or closed.

FIGS. 29A, 29B, 29C and 29D show a method of determining if the timer relay has “clicked” to produce a symbol, and illustrate a preferred embodiment. FIG. 29A shows three A/C cycles where the center cycle is where the timer relay has opened to produce the symbol or other indication. For the two ½ cycles 135 and 136, between the two zero crossings 120A and 120B, the voltage is zero because the relay has opened. FIG. 29A shows the voltage coming from the relay going to the receiver module in the fixture. The voltage is 277 VAC which peaks at plus and minus 388V. As shown in FIG. 20 this high line voltage is reduced by voltage divider resistors 103, 114, 115 and 116 by approximately 1/100 down to a voltage that will peak at 4V so that it can safely be input into the receiver microprocessor A/D input pin #6 at 117. This reduced voltage is shown in FIG. 29B. The voltage shape is exactly the same as the high voltage in FIG. 29A except that the voltage is reduced by a factor of 100.

In FIG. 29C at 180 the points where the microprocessor takes voltage measurement samples are shown as short vertical lines. There are shown 16 samples per full AC cycle, or 8 samples per AC ½ cycle as shown. FIG. 29C shows where the samples preferably are taken. FIG. 29D shows the result of the 48 samples taken for 3 AC cycles. The A/D circuit of the microprocessor can only measure positive voltages, as is conventional. Any negative voltages will always measure zero volts such as shown at point 170. Both the first cycle and the third cycle that have a normal AC waveform produce what is referred to as a normal voltage snapshot. This is the set of 16 voltage measurements when the relay has produced no symbol, where the relay has not opened at all. The three measurements that are numbered 174, 175 and 176 are measurements that correspond to the waveform shown on FIG. 29B. They effectively measure a 4VPP sine wave. The third cycle, which is another normal cycle, produces the same measurements.

The center cycle is the cycle where the relay has opened produces a message symbol. As shown in FIG. 29B the voltage is zero for the two ½ cycles 172 and 173. Now the voltage measurement snapshot of 16 measurements is very different. All the measurements, including the three that are numbered 177, 178 and 179 are zero. There is a clear difference between the 16 measurements of the 1^{st} and 3^{rd} cycles, which follow the shape of a sine wave, and the 16 measurements of 2^{nd} cycle, which are all zeros. FIG. 29 shows how the receiver microprocessor A/D input is used to measure the voltage at selected sample points throughout the AC cycles.

FIGS. 30A, 30B and 30C show how the AC measurements at a receiver module would appear if the receiver module is on a different phase than the timer relay producing the “click” or symbol. This can occur if there is a contactor positioned between the timer relay and the circuit that is connected to a contactor powering the fixtures. FIG. 30A shows the timing that comes from the timer relay on Phase A. FIG. 30A is identical to FIG. 29A.

FIG. 30B shows the waveform that appears to the receiver module which is on a circuit connected to a contactor connected to Phase B. This AC waveform of Phase B is shifted by 120 degrees from Phase A. In FIG. 30B two AC cycles are shown. Because the missing two ½ cycles in FIG. 30A are offset from the two AC cycles shown in FIG. 30B the points where the waveforms are at zero volts, 180, 181, 182, and 183 take place in 2 different AC cycles instead of only one AC cycle as in FIG. 30A. FIG. 30C shows the 16 voltage measurements for the 1^{st} and the 2^{nd} AC cycles at the receiving module. It can be seen that in the first AC cycle part of the measurements are normal 184, 185 and part are zero indicating the presence of an anomaly or symbol, at 186. For the second ac cycle, parts of the cycle are normal, 187, and 189, and part is zero 188, indicating an aberration or symbol. The result is that the original symbol at 135 and 136 in FIG. 30A appears in FIG. 30B and 30C partially in one AC cycle and partially in the following AC cycle.

The conclusion is that in order to best detect a symbol the receiving module must examine two consecutive cycles to capture a symbol that may have been produced on a different phase than the phase on which the receiving module is located. Also there are other reasons the offsets produced by relay timings may result in offsets in the symbol, “clicking” produced such that the symbol may be shifted to partially appear on each of two consecutive AC cycles and not only one AC cycle.

One other reason this is very important is that certain timers or lighting panels may not have access to the zero crossing timings for the relays so the only signals, or clicks” then produced can be set to be one AC cycle in duration but not synchronized in any way to zero crossing. In this case the resulting symbol of 16.6 msec in length, almost always will randomly appear partially over two consecutive AC cycles. This is easy for a receiver module to detect reliably as long as each measurement is examined over two consecutive AC cycles.

For example, if cycles are numbered 1,2,3,4,5,6,7 then the receiving module must examine cycles 1 and 2 for a symbol, and then examine cycles 2 and 3 and then examine cycles 3 and 4 and then examine cycles 4 and 5, and so on.

FIGS. 31A, 31B, 31C, 31D and 31E show examples of how a message symbol corresponding to missing voltage measurements, or zero voltage measurements, and that indicate a symbol is present may appear over one or two AC cycles.

In FIG. 31A, B, C, D and E, there are three AC cycles displayed. FIG. 31A shows locations of the 16 sample points for each of the three consecutive AC cycles displayed.

FIG. 31B shows 3 normal AC cycles with no relay clicking and no symbol present. The measurements are all measurements that would be produced with the normal AC waveform present. In all three cycles point 191 is zero because the actual voltage into the receiver is negative, and the microprocessor cannot measure negative voltages, so the result is zero. The other samples, such as 192 and 193 indicate the normal AC sine wave voltage measurements, which indicate no symbol is present.

FIG. 31C shows a symbol present in the center AC cycle where the normal measurements 192 and 193 are completely missing and the measurements 194 and 195 measure zero voltage. It is clear that a symbol is present on the center AC cycle in FIG. 31C.

FIG. 31D shows a symbol present in the 1^{st} and 2^{nd} AC cycles. In the 1^{st} AC cycle the normal measurements 192 and 193 are present but the measurement 196 toward the end of the cycle is missing and measurement 197 measures zero voltage. In the 2^{nd} AC cycle measurements 192 and 193 are missing and are replaced by the measurements 194 and 195 which measure zero volts.

FIG. 31D shows a symbol present in the 1^{st} and 2^{nd} AC cycles. In the 1^{st} AC cycle the normal measurements 192 and 193 are present bur the measurement 196 toward the end of the cycle is missing and measurement 197 measures zero voltage. In the 2^{nd} AC cycle measurements 192 and 193 are missing and are replaced by the measurements 194 and 195 which measure zero volts.

FIG. 31E shows a symbol present in the 2^{nd} and 3^{rd} AC cycles. In the 1^{st} AC cycle the normal measurements 191, 192, 193 and 196 are present and there is no symbol present. In the 2^{nd} cycle the measurement 196 toward the end of the cycle is missing and measurement 197 measures zero voltage. In the 2^{nd} AC cycle measurements 193 and 196 are missing and are replaced by the measurement 197 which measures zero volts. In the 3^{rd} cycle measurement 192 is missing and is replaced by measurement 198 which measures zero volts.

FIGS. 32A, 32B, 32C and 32D show a method of calculating the difference between a missing cycle measurements and a normal cycle measurements and using the results of that calculation to reliably determine if a symbol was present or not.

FIG. 32A shows the 16 receiving module microprocessor A/D measurement points 190 for each of the two AC cycles being compared.

FIG. 32B shows the normal cycle measurements when no symbol is present, 200, 201, 202, and 203, which follows the pattern of a normal sine wave. Also shown at 200, 201, 202, and 203 are the normal voltage measurements of 0V, 4V, 6V and 8V, respectively.

FIG. 32C shows the normal cycle measurements when no symbol is present in the 1^{st} cycle and a symbol is present in the 2^{nd} cycle. For the 1^{st} cycle measured points 200, 201, 202, and 203 follow the pattern of a normal sine wave. Also shown at 200, 201, 202, and 203 are the normal voltage measurements of 0V, 4V, 6V and 8V, respectively. For the 2^{nd} cycle measurements 201, 202, and 203, are all missing and are replaced with 204, 205, and 296, all of which measure zero volts.

The calculations for the 1^{st} cycle in FIG. 32D are shown at 207, and 208. At 207 each of the 16 measurements are individually subtracted from the “normal” 16 voltage measurements. Because of small random differences in measurements the sum of all 16 differences is a total of 2, shown at 208.

The calculations for the 2nd cycle in FIG. 32D are shown at 209, 210. At 209 each of the 16 measurements are individually subtracted from the “normal” 16 voltage measurements. Because a symbol is present there are large differences in measurements, and the sum of all 16 differences is a total of 42, shown at 210.

If a set point of 20 was chosen for the difference number required for a cycle to be a symbol then the 1^{st} AC cycle at a total difference of 2 would not count as a symbol, but the 2^{nd} AC cycle with a difference of 42, being greater than the set point of 20 would be defined as a symbol. This is a very simple mathematical way the receiving microprocessor can determine if a cycle should be determined to be a symbol or not.

FIGS. 33A, 33B, 33C and 33D are similar to the FIGS. 32A-D, except that the symbol is partially present on the 1^{st} AC cycle and partially present on the 2^{nd} AC cycle. These figures demonstrate that the measurement differences method can easily be used even if the symbol is present, but spread out on two consecutive AC cycles. It is important to consider two consecutive cycles and their differences and not just consider each cycle separately. This situation is believed to be very probable. If the symbol is created by the timer relay being opened for 1 full AC cycle, which is 16.66 msec in a 60 HZ power system, there are many different reasons that the time period the relay is open may not be very well synchronized to the zero crossings of the receiving modules. That is, the time the relay is open may not coincide with a full complete cycle at the receiving module. Some possible reasons the symbol will be spread across more than one AC cycle are:
The timer firmware may try to open and close the relay at zero crossing but the delay times to activate the relay coil may be off somewhat, thus leading to opening and closing times of the relay contacts that are also off.
The receiving module may be installed on a fixture that is connected to a contactor on a different phase than the phase that powers the contactor coil.
The delay times of the contactor opening and closing are unknown so that the timer has little or no control of when the actual open and closing times of the contactor will occur.

FIG. 33A shows the 32 sample points 190. FIG. 33B shows two normal AC cycles with the measurements 200, 201, 202, 203, 219 and 220. For an example, voltage measurements on the points of 0V, 4V, 6V, 8V, 4V and 3V, respectively, are shown. This is a normal AC waveform following a normal sine wave, with no symbol, or “clicking” present. This normal pattern is present both in the 1^{st} and 2^{nd} AC cycle in FIG. 33B.

FIG. 33C shows two AC cycles with a symbol starting in the 1^{st} AC cycle and finishing in the 2^{nd} AC cycle. The measurements 200, 201, 202, 203 are the same as a normal cycle but measurements 219 and 220 which, were 4V and 3V, are missing and are replaced with measurements 211 and 212 which are both 0V. On the 2^{nd} AC cycle measurements 201, 202 and 203 are missing and are replaced by 213 and 214 which measure 0V. In measurements 215 and 217 the voltage differences between a normal cycle and these two AC cycles are listed.

If these two AC cycles were normal cycles with no symbol the differences would be very close to 0. As shown in FIG. 34D, because there is a symbol partially present in both AC cycles the list of sample point measurement differences, shown at 215 and 217, is 0 0 0 0 0 0 0 0 0 0 0 0 6 4 3 1 and 0 0 0 0 0 0 0 0 1 2 3 8 8 0 0 0 0 0. The differences for the 1^{st} AC cycle total 14 at 216 and for the 2^{nd} AC cycle total 31 at 218 for a grand total for both consecutive cycles of 45. If the test value was set or defined to be 20 for a symbol to be present on two consecutive cycles, then clearly the value of 45, which is greater than 20, would indicate that a symbol is present.

This method that uses voltage measurements is much more reliable than the method that only detects if the voltage is high or low. It is very difficult, if not practically impossible for small noise pulses to cause errors when using this method.

FIGS. 34A and B show a method similar to the method shown in FIGS. 29, 30, 31, 32 and 33 except that instead of the relay opening for an entire 16.66 msec cycle the relay only opens for a few msec before and after zero crossing. The reason this method may be important is that the relatively short open and close times will produce a much smaller effect on the LED fixture. Depending upon the type of LED driver used it may be advantageous to minimize the LED flickering when the power relay opens and closes. The shorter the open/close time the less disturbance of the LED driver power supply and the less chance there will be any observable flicker in the LED bulb or fixture.

The process shown in FIG. 34 may be referred to as the MINIMUM DISTURBANCE METHOD OR PROCESS because it is designed to use a very short open/close time that is centered about a zero crossing. With this method measurements need only to be taken during the time the relay might be opened. FIG. 34A shows a normal waveform with no relay opening and no symbol present. There are seven measurements 230 to 236. These measurements are 0V, 0V, 0V, 0V, 2V, 4V, AND 6V respectively. The A/D circuit in the microprocessor cannot measure negative voltages so the first three measurements at 230, 231 and 232 are all 0V even though the actual voltage is negative.

A simple calculation result is shown at 240. The difference between this calculation for these wave measurements and the calculation for normal wave measurements is shown at 239 and the total difference is at 240 which=0.

In FIG. 34B a symbol is present and the relay is open before and after zero crossing 233. Measurements in a normal wave in FIG. 34A, at 234 and 235, 2V and 4V, respectively are missing and replaced with measurements of 0V and 0V. The calculations for the differences for these seven measurements are shown at 241 to 244, and the total difference=6, which indicates a symbol is present.

In these examples there are seven measurements shown for clarity on the drawings, but in practice the number of measurements can be increased to obtain better resolution and increased noise immunity.

FIG. 35A shows preferred connections for the receiving module 22, which is normally an add-on device installed into a LED fixture and is connected to line 9 and to neutral 7, and for the two 0-10V lines 20 and 21 that control the LED driver 12, which powers the LEDs 12.

FIG. 35B shows that the logic and functionality of the receiving module 23 can easily be built directly into a LED driver 12, and which then only needs to be connected to line 9 and neutral 7, thereby eliminating the connections 20 and 21 and the need to install an add-on device. It is believed that there are significant advantages to integrating the receiving module, which is considered to be part of the presently disclosed systems and processes, directly into a series of LED drivers.

It is believed that the receiving logic as described and shown above, can also be integrated directly into the LED driver Integrated Circuit (IC) to further simplify the process of adding dimming and level setting capabilities to any LED fixture or bulb. Therefore, in accordance with preferred embodiments disclosed herein, there are three different levels of integration possible and practical. First, the fixture module can be a separate add-on device. Second, the logic and functionality of the process can be integrated inside of add-on, separate LED drivers. Third, the logic and functionality of the system can be integrated inside of LED drivers' Integrated Circuits (ICs).

FIG. 36A, B and C show how timer relay “clicking” can be used to construct different messages. FIG. 36A shows a series of AC sine waves. Most of these are normal AC waves 251, but three of them, shown at 250, 250, 250 show an absence of AC voltage when the timer relay clicked open for one full cycle. FIG. 36B shows the number of cycles between the three different open cycles 251, 251, 251. The two different gaps between relay clicks are shown to be 8 cycles 252 and 13 cycles 253.

FIG. 36C is an expansion of FIG. 36A and shows how a series of relay clicks producing a series of symbols can be used to construct a message with multiple gaps, which in turn can represent more complex data or instructions. FIG. 36C shows seven different gaps created by 8 different clicks, or symbols. The gaps are shown between 8, 13, 3, 8, 16, 8, and 10 cycles, respectively, at 252 to 258. These 7 different gaps could be used, for example to represent 4 bit nibbles and to build a complete message. The message could be built, for example, from gap#1 at 252, gap#2 at 253, gap#3 at 254, and so on.

FIG. 37 shows the message structure that is used in the current preferred embodiment of the timer. The purpose of this simple message structure is to allow the timer to set the lighting level of the LED fixtures by means of the receiving module which receives these different messages and sets its' output 0-10V signal to the appropriate level that corresponds to the message received.

FIG. 37 includes four headings. First, reference numeral 260 refers to the number of cycles between the start symbol, or 1^{st} relay click, and the end symbol, or 2^{nd} relay click. Second, reference numeral 261 refers to the message type. Third, the reference numeral 261 refers to the message action 262. And, fourth, the reference numeral 263 refers to a 0-10V output voltage. The first row of the table provides values for an exemplary first message. The number of cycles in the gap is 24 cycles, shown at 264. The 5-bit D/A converter is set to a binary 00000 shown at 265. The action is to set the lighting to 0% shown at 266. The 0-10V output is set to 0.0 VDC, shown at 267.

Although specific embodiments of the disclosure have been described, various modifications, alterations, alternative constructions, and equivalents are also encompassed within the scope of invention as set forth in the claims.

The specification and drawings are, accordingly, to be regarded in an illustrative rather than a restrictive sense. It will, however, be evident that additions, subtractions, deletions, and other modifications and changes may be made thereunto without departing from the broader spirit and scope of invention as set forth in the claims.

What is claimed is:

1. A load control system comprising:
An electrical power system including electrical power supplied by a power transformer having one or more electrical phases;
said transformer connected to supply power to loads and adapted to be controlled through one or more circuit breakers installed in one or more circuit breaker panels;
a load control device having power input connections to one or more said circuit breakers of one of said circuit breaker panels;
said load control device having power output connections to one or more circuits adapted to supply power to one or more electrical lighting loads;
said load control device having one or more electrical switch devices connected between said power input connections and said power output connections and adapted to control power to said electrical lighting loads;
said load control device having an integrated circuit adapted to control the on or off state of said one or more electrical switch devices;
said integrated circuit programmed to operate said one or more electrical switch devices in a predefined pattern to send predefined messages to said electrical lighting loads.

2. The load control system of claim 1 wherein said electrical lighting loads are lighting fixtures.

3. The load control system of claim 1 wherein predefined messages are adapted to change the lighting level of said electrical lighting loads.

4. The load control system of claim 1 where said switch devices are mechanical power relays or electronic switch devices selected from the group consisting of triacs, FETs and transistors.

5. The load control system of claim 1 where said predefined pattern is a predetermined time relative to AC zero-crossing when power is first applied to said electrical lighting loads.

6. The load control system of claim 1 where said predefined pattern is produced by controlling said switch devices to remove and then reapply power for a predetermined period.

7. The load control system of claim 1 where said predefined pattern is produced by controlling said switch devices to remove and then reapply power at one or more predetermined times relative to the powerline voltage zero crossing time.

8. The load control system of claim 1 where said predefined pattern is adapted to minimize the power interruption at said electrical lighting loads.

9. The load control system of claim 1 where said load control device is a wall box timer.

10. The load control system of claim 1 where said load control device is a relay lighting panel.

11. The load control system of claim 1 where said system includes a receiving device installed in said electrical lighting loads where said receiving device is adapted to detect said predefined patterns and to then change the lighting level in said electrical lighting loads.

12. The system of claim 11 wherein the receiving device is adapted to produce a 0-10 VDC output signal that can be connected to the 0-10 VDC input connection of a ballast or LED driver.

13. The system of claim 11 wherein the receiving device includes 0-10 VDC output signal output adapted to be set to a limited number of preset levels each in response to different said predefined patterns.

14. The preset levels of claim 13 where said preset levels are high, medium, low and off.

15. The receiving device in claim 11 adapted to change the lighting level by controlling one or more controlled outputs on said receiving device, and wherein said outputs are adapted to be connected to conventional inputs of a stepped-level type ballast or LED driver.

16. The load control system of claim 1 where said electrical lighting loads are not connected directly to said switch device in said load control device, but are connected to the output of a lighting contactor device installed between said load control device and said electrical lighting loads and said lighting contactor device is adapted to be controlled by an output of said load control device.

17. The load control device of claim 16 adapted to set different timing settings to allow different predefined patterns to be created if said lighting contactor device is installed in between said load control device and said electrical lighting loads.

18. A load control system comprising:
a load control receiving device with input connections to AC line and AC neutral;
said load control receiving device with 0-10V output control connections;
said one or more lighting drivers including AC line and AC neutral power input connections;
said one or more lighting drivers including 0-10V input level control connections;
the ON or OFF state of said one or more lighting drivers controlled by the presence or absence of AC power on said AC line power input connection;
the said presence or absence of said AC power on said AC line power input connection of said one or more lighting drivers controlled by some other control device other than said load control receiving device;
said load control receiving device having NO power output control lines to connect to said AC line power input connection of said one or more said lighting drivers;
said load control receiving device having means to receive a plurality of different messages on said input connections to AC line and AC neutral;
said messages composed of predefined patterns on the sine wave of said AC line,
said load control receiving device setting the voltage on said 0-10V output connections at different levels depending on which one of said a plurality of different messages were received.

19. A method for changing the light level in one or more lighting fixtures connected to a control device with one or more power wires where said control device incorporates a switch type device capable of turning the power on and off to said one or more lighting fixtures, comprising the steps of:
operating said switch type device in a manner to produce a predetermined pattern on the AC waveform of said one or more power wires, and
operating said switch type device to control primary on and off AC power to AC power input connections of said one or more lighting fixtures, and
installing a receiving device in said one or more lighting fixtures capable of detecting two or more different said predetermined patterns on the AC waveform, and
having an output connection in said receiving device capable of generating a signal capable of changing the lighting level in one or more controllable ballasts or drivers installed in said lighting fixtures.

20. The method of claim 19 where switch type device is a conventional power relay.
